(19) United States
(12) Patent Application Publication
(10) Pub. No.: US 2005/0137734 A1
(43) Pub. Date: Jun. 23, 2005

(54) Method of operating a lithographic apparatus or lithographic processsing cell, lithographic apparatus and lithographic processing cell

(75) Inventors: Norbertus Josephus Martinus Van Den Nieuwelaar, Tilburg (NL); Johannes Onvlee, s-Hertogenbosch (NL); Henricus Petrus Johannus Van Lierop, Weert (NL); Niels Cornelis Wilhelmus Maria Braspenning, Zundert (NL); Jacobus Eelkman Rooda, Eindhoven (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 10/846,854

(22) Filed: May 17, 2004

Related U.S. Application Data
(63) Continuation-in-part of application No. 10/743,320, filed on Dec. 23, 2003, now abandoned.

(51) Int. Cl. G06F 19/00

(52) U.S. Cl. 700/100; 700/121

(57) ABSTRACT

A method of generating a schedule for operation of a machine forming at least a part of a lithographic apparatus or a lithographic processing cell is disclosed. In the method, a plurality of weight factors are received for respective ones of a plurality of qualities affecting the outcome of a lithographic process. An optimum schedule of tasks to be performed to complete said lithographic process is generated, the optimum schedule being one whose outcome has a maximum value of total quality, where total quality is the sum of the products of the values of each of said qualities and the respective weight factors.

This application is a continuation-in-part of U.S. patent application Ser. No. 10/743,320 filed Dec. 23, 2003, the entire contents of which are incorporated herein by reference.

### FIELD

The present invention relates to lithographic apparatus and lithographic processing cells, and the methods of operating such.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, such as a mask, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the projection beam in a given direction (the “scanning”-direction) while synchronously scanning the substrate parallel or anti-parallel to this direction.

In a factory, commonly referred to as a “fab” or “foundry”, in which semiconductor devices are manufactured, each lithographic apparatus is commonly grouped with a “track” comprising substrate handling devices and pre- and post- processing devices to form a “lithocell”. Both the lithographic apparatus and the track typically have supervisory control systems which are themselves under the control of a further supervisory control system. Substrates, which may be blank or have already been processed to include one or more process or device layers, are delivered to the lithocell in lots (also referred to as batches) for processing. A lot is, in general, a group of substrates which are to be processed by the lithocell in the same way and is accompanied by a “recipe” which specifies the processes to be carried out. The lot size may be arbitrary or determined by the size of carrier used to transport substrates around the fab. The recipe may include details of the resist coating to be applied, temperature and duration of pre- and post- exposure bakes, details of the pattern to be exposed and the exposure settings for that, development duration, etc. A large number of tasks must be performed to complete the recipe for a given batch and there are many possible ways these can be done, as in many cases both the track and lithographic apparatus are capable of performing multiple tasks at once, e.g. if the track includes multiple spin coaters or multipurpose stations or if the lithographic apparatus is a dual stage apparatus having measurement and exposure stations. Thus scheduling the tasks to be performed, and optimizing that schedule, e.g. to maximize throughput, is a complex task.

In most cases, on-the-fly scheduling is limited and most sequences of tasks are hard-coded in the control software of the apparatus or the supervisory control system. A more flexible approach to scheduling is to construct a tree based on tasks to be completed and their precedence relation. In such a tree, starting from an origin, branches represent possible tasks that may be carried out and lead to leaves, from which further branches represent tasks that may then be carried out, and so on. Scheduling then becomes a matter of selecting a path through the tree. However such scheduling may not take into account the restrictions caused by the physical layout of the apparatus, nor the possibility of choices between tasks.

### SUMMARY

Accordingly, it would be advantageous, for example, to provide an improved method of scheduling tasks in a machine such as a lithographic apparatus and lithographic processing cell.

According to an aspect, there is provided a method of generating a schedule for operation of a machine forming at least a part of a lithographic apparatus or a lithographic processing cell, the method comprising:
receiving a plurality of weight factors for respective ones of a plurality of qualities affecting the outcome of a lithographic process;
generating an optimum schedule of tasks to be performed to complete said lithographic process, said optimum schedule being one whose outcome has a maximum value of total quality, where total quality is the sum of the products of the values of each of said qualities and the respective weight factors.

The method may enable improvements in machine behavior, as a run-time (optimized) schedule can be generated. Heuristics capturing effective intuitive rules for the application domain are used to direct the schedule generation process. By design-time simulation/verification, it can be ensures that the generated schedule will be valid. Techniques for verification are discussed below. Optimization of the schedule, by iterating through possible/promising schedules, dynamically adapting to a better schedule as soon as one is found, while the machine continuously remains active can improve throughput and/or the quality of the manufactured devices with no additional overhead. Further optimization of the schedule by means of a post-processing step on a complete schedule, for example thus taking timing knowledge of an entire lot of substrates into account, is possible.

Optimization of a schedule may include adjustment of parameters of a task. For example, an exposure or alignment task may be more accurate if performed at a slower scan speed and so optimization of the schedule may allow a slower scan speed, especially if that does not affect the critical path.

In an embodiment, the generation of schedules is carried out with reference to a model of the machine. The model of the machine basically comprises of tasks (the things to do) and resources (the things that can be employed to execute tasks). The execution order of tasks is restricted by precedence relations.

An embodiment of the present invention can be considered as an extension of generalized job shop scheduling techniques, which conventionally consider only the order of tasks and the assignment of resources. The extension comprises considering alternatives with respect to tasks, optional tasks, material constraints, resource conflicts and deadlock avoidance.

Alternatives with respect to tasks are, in an embodiment of the invention, handled by defining groups of equivalent tasks—in a particular embodiment a group is defined as a set of nodes where a node may be a task, a cluster of tasks or another group—and a limit on the number of tasks that may be selected from the group. The number of tasks that can be selected may be a specific value, e.g. 1, indicating that exactly that number of tasks must be selected from the group, or a set of values, allowing choice over the number of tasks selected. Thus for optional tasks, the limit may be set as 0 or more. By way of an example, a substrate may be provided with 25 marker pairs of which 16 pairs must be scanned to provide a minimum level of alignment accuracy. Scanning additional marker pairs may provide additional accuracy. Thus tasks may be defined to scan each marker and clustered in pairs. The clusters are put in a group which has a selection limit of 16 to 25.

According to another aspect of the invention, there is provided a method of operating a machine forming at least a part of a lithographic apparatus or a lithographic processing cell, the method comprising:
providing a model of the machine in an initial state;
determining eligible tasks that can be performed by the machine based on the state of said model;
selecting one or more of said tasks according to at least one predetermined criterion;
adding the one or more selected tasks to a partial schedule;
updating said model to reflect completion of said one or more selected tasks;
detecting whether the machine is idle and if so controlling it to perform said partial schedule; and
repeating said determining, selecting, adding, updating and detecting until all tasks necessary to complete a lithographic process have been scheduled.

A schedule is generated in a constructive way, starting from the beginning to determine the next “valid” or “eligible” tasks (i.e. obeying constraints of the machine and the manufacturing process) to perform. Instead of determining all possible schedules, heuristic filters can be used to direct the schedule generation. Examples of heuristic rules are First Start First, Preferred Resources, and Priority Tasks.

The dispatch of partial schedules in the case that the machine is idle, eliminates any scheduling overhead. Such partial schedules may consist of only one task so also providing the benefits of state-based control.

The durations of tasks are taken into account, including the duration needed for resource preparation or setup, which may depend on the previously executed task(s) and the state in which the resource is left. Durations can be determined by several means: 1) by design, or calibration—for tasks which will always have the same duration in different contexts, the timing of each task can be measured once, and stored in the system; 2) by using dedicated mathematical functions—for tasks which depend on many parameters, which are only known during runtime, e.g. coordinate, dose, speed, acceleration, etc.; and/or 3) by dynamically monitoring durations, and using moving average (MA) values—for tasks of which the duration may change slowly over time.

The default heuristic to schedule a task may be “As Soon As Possible” (ASAP). If the machine is idle, the first task chosen will be dispatched immediately, which can be done as the schedule is generated in a constructive way. In this approach, (possibly) sub-optimal schedule solutions are permitted in favor of just getting the machine to start work. If the system is not idle, the next tasks will be added to a queue, comparable to a “heap of pieces” and a post processing step may be performed on the resulting schedule, to optimize it.

The post-processing step may involve adjusting the relative timings of tasks and adjustable parameters of tasks but not the tasks selected, the order of tasks in the schedule or resource allocations. In particular, a transport task, such as the transfer of a substrate from a substrate table after exposure or from a pre-aligner to a substrate table for exposure, may be scheduled to be carried out “As Late As Possible”—that is as late as the task can be carried out without delaying the critical path. Determination of when as late as possible is may take account of other tasks using the resource and other tasks that may interfere with the task being delayed. This approach may be beneficial where the transport task involves moving the substrate from a resource where it is conditioned, e.g. temperature controlled or bathed in clean air, since it ensures that the minimum time is spent in unconditioned surroundings.

In many cases, multiple solutions are possible for “valid/eligible” tasks. While the system is already working on a (possibly sub-optimal) schedule, the scheduler may iterate through the schedule generating process, each time selecting different valid paths, in an attempt to find a better schedule. Possibilities are explored from the beginning to the end, for the same reason as the constructive schedule generation. Each time a better schedule is found, the scheduler may change to this better schedule (cache), taking into account the tasks that have already been executed or dispatched.

To ensure that workable schedules are created, various configurable constraints may be applied. These may relate to logistic integrity, material flow deadlocks and hardware interference.

For example, to preserve logistic integrity, the scheduler may ensure that the resources assigned to execute certain tasks in the ‘life of a material’ are consistent: e.g. if a substrate is loaded onto a first substrate table in a dual stage apparatus, it must also be processed on that substrate table thereafter. Also, the scheduler may ensure that the combination of resources involved in material transport is feasible. For example, a mask may only be transported from a transfer robot onto one turret elevator, not onto the other. A further example is to ensure that the material capacities of the resources of the machine, either individually or in sets, are not exceeded. For example, a mask library may only be able to contain a limited number of masks, a mask table may only have one, etc. To satisfy these additional constraints, logistic task information is defined, and logistic bookkeeping is integrated in the scheduler. Throughout construction of the schedule, the constraints are checked.

How deadlocks in a material's life may be dealt with can be illustrated by an example: if a mask is to be preloaded from a mask input lock to a turret by two subsequent tasks lock-robot, and robot-turret, it must be possible to not only execute lock-robot, but also robot-turret subsequently. To avoid this type of deadlock, ‘tied precedences’ can be used. The decision to schedule one of the tasks that are ‘tied together’ considers the eligibility of the entire ‘tie’. In other words, the first task is only scheduled if the entire tie can be scheduled. An example of a deadlock concerning multiple material lives is the limit that the turret and the mask table may contain only two masks in total. This means that there can be no preload if there is already a mask on the mask table and another on the turret. To avoid this type of deadlocks, a Work In Process constraint is employed.

Hardware interference constraints include that some resources have to move synchronously for certain moves: e.g. substrate table swap. These situations can be defined and taken into account by the scheduler when determining ‘setup’ or ‘preparation’ tasks. Another constraint is that some resources can collide in certain collision-hazardous areas. To avoid this type of interference, each collision-hazardous area can be defined as a mutually exclusive resource. These resources are then automatically assigned by the scheduler if the physical resource (e.g. robot) crosses the area.

The machine may be the whole of a lithographic processing unit, comprising a lithographic apparatus and a track unit comprising substrate handling devices and pre- and post-processing devices, or just the lithographic apparatus or just the track unit or just a subsystem within the lithographic apparatus or track unit.

According to a further aspect of the invention, there is provided a supervisory control system to operate a machine forming at least a part of a lithographic apparatus or a lithographic processing cell, the control system comprising:
an input device configured to receive a plurality of weight factors for respective ones of a plurality of qualities affecting the outcome of a lithographic process;
a scheduler configured to generate an optimum schedule of tasks to be performed to complete said lithographic process, said optimum schedule being one whose outcome has a maximum value of total quality, where total quality is the sum of the products of the values of each of said qualities and the respective weight factors.

According to further aspect, there are provided a lithographic processing cell, a lithographic apparatus and a track unit, each including a control system as described above.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to any device that can be used to impart a projection beam with a pattern in its cross-section such as to create a pattern in a target portion of the substrate. It should be noted that the pattern imparted to the projection beam may not exactly correspond to the desired pattern in the target portion of the substrate. Generally, the pattern imparted to the projection beam will correspond to a particular functional layer in a device being created in the target portion, such as an integrated circuit.

A patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned. In each example of a patterning device, the support structure may be a frame or table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “lens” herein may be considered as synonymous with the more general term “projection system”.

The illumination system may also encompass various types of optical components, including refractive, reflective, and catadioptric optical components for directing, shaping, or controlling the projection beam of radiation, and such components may also be referred to below, collectively or singularly, as a “lens”.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a lithographic processing cell according to an embodiment of the invention;

FIG. 3 depicts a control system for the lithographic apparatus of FIG. 1;

FIG. 4 depicts definition levels of Task Resource Systems (TRS);

FIGS. 4a and b are UML class diagrams of TRS definition levels 1 and 2;

FIG. 5 is a flow diagram of a method according to an embodiment of the invention;

FIG. 6 depicts the mask handling arrangements in an apparatus according to an embodiment of the invention and certain tasks that may be performed by the apparatus;

FIG. 7 is a Gantt chart of an example task schedule generated by a method according to an embodiment of the invention;

FIG. 8 is a Gantt chart showing the critical path of the example schedule of FIG. 7;

FIG. 9 is a Gantt chart of a second example task schedule generated by a method according to an embodiment of the invention;

FIG. 10 is a Gantt chart showing the critical path of the example schedule of FIG. 9;

FIG. 11 depicts the substrate handling arrangements in an apparatus according to an embodiment of the invention showing an area of possible resource conflict;

FIGS. 12 to 16 depict various resource automata;

FIG. 17 depicts a sequence of tasks in the life of a substrate;

FIG. 18 depicts a sequence of tasks in the life of a substrate omitting setup tasks;

FIG. 19 depicts transport tasks and material occupation tasks;

FIG. 20 is a view similar to FIG. 11 also illustrating a possible deadlock;

FIG. 21 is a Gantt chart of a third example task schedule generated by a method according to an embodiment of the invention;

FIG. 22 is a Gantt chart showing the critical path of the example schedule of FIG. 21;

FIG. 23 depicts substrate handling arrangements according to a particular embodiment of the invention;

FIGS. 24 to 27 are automata of the resources of a particular embodiment of the invention;

FIG. 28 depicts a sequence of tasks in the lives of three substrates;

FIGS. 29 to 32 are diagrams of the substrate handling arrangements of a particular embodiment showing possible deadlock situations;

FIG. 33 is a Gantt chart of a fourth example task schedule generated by a method according to an embodiment of the invention;

FIG. 34 is a Gantt chart showing the critical path of the example schedule of FIG. 33;

FIG. 35 is a Gantt chart of a fifth example task schedule generated by a method according to an embodiment of the invention;

FIG. 36 is a Gantt chart of a sixth example task schedule generated by a method according to an embodiment of the invention; and

FIG. 37 is a graph showing post exposure bake times for the schedules of FIGS. 33, 35 and 36.

### DETAILED DESCRIPTION

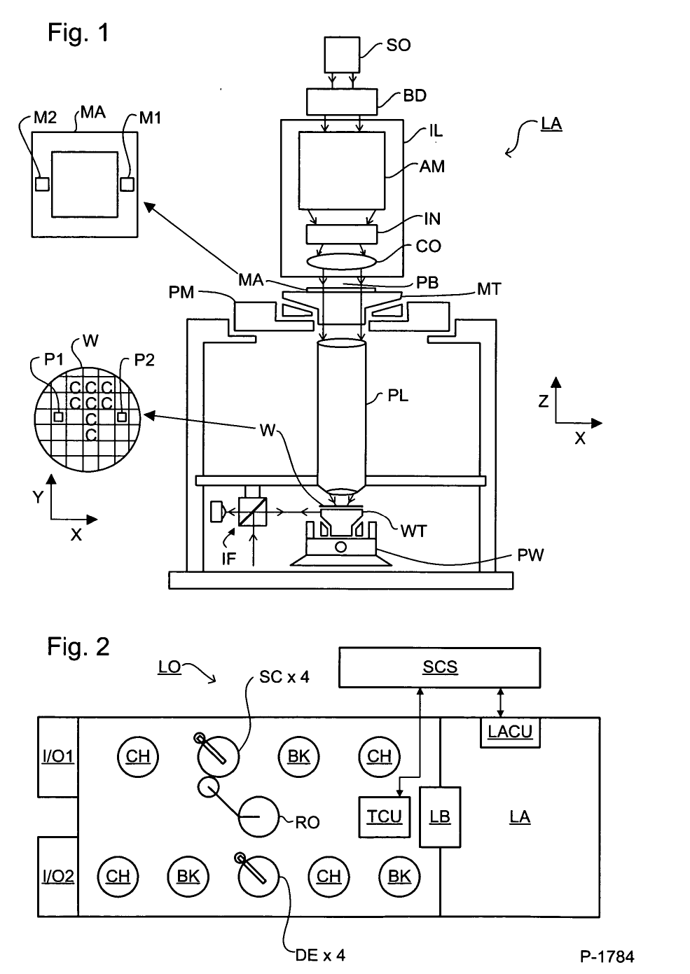

FIG. 1 schematically depicts a lithographic apparatus according to a particular embodiment of the invention. The apparatus comprises:
an illumination system (illuminator) IL for providing a projection beam PB of radiation (e.g. UV radiation or DUV radiation).
a first support structure (e.g. a mask table) MT for supporting a patterning device (e.g. a mask) MA and connected to a first positioning device PM for accurately positioning the patterning device with respect to item PL;
a substrate table (e.g. a wafer table) WT for holding a substrate (e.g. a resist-coated wafer) W and connected to a second positioning device PW for accurately positioning the substrate with respect to item PL; and
a projection system (e.g. a refractive projection lens) PL for imaging a pattern imparted to the projection beam PB by patterning means MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise an adjusting device AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation, referred to as the projection beam PB, having a desired uniformity and intensity distribution in its cross-section.

The projection beam PB is incident on the mask MA, which is held on the mask table MT. Having traversed the mask MA, the projection beam PB passes through the lens PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the mask MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning means PM and PW. However, in the case of a stepper (as opposed to a scanner) the mask table MT may be connected to a short stroke actuator only, or may be fixed. Mask MA and substrate W may be aligned using mask alignment marks M1, M2 and substrate alignment marks P1, P2.

The depicted apparatus can be used in the following preferred modes:
1. In step mode, the mask table MT and the substrate table WT are kept essentially stationary, while an entire pattern imparted to the projection beam is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.
2. In scan mode, the mask table MT and the substrate table WT are scanned synchronously while a pattern imparted to the projection beam is projected onto a target portion C (i.e. a single dynamic exposure). The velocity and direction of the substrate table WT relative to the mask table MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.
3. In another mode, the mask table MT is kept essentially stationary holding a programmable patterning means, and the substrate table WT is moved or scanned while a pattern imparted to the projection beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes a programmable patterning means, such as a programmable mirror array of a type as referred to above.

Combinations and/or variations on the above described modes of use or entirely different modes of use may also be employed.

The lithographic apparatus LA shown in FIG. 1, forms part of the lithographic processing cell, or lithocell, LO shown in FIG. 2. As well as the lithographic apparatus LA, the lithocell LO includes input/output ports I/O1 and I/O2 (a single port or more than two may also be provided), chiller plates CH for cooling substrates, bake plates BK for heating substrates, spin coaters SC (typically four) for coating substrates, e.g. with resist, developers DE (again typically four) and a substrate handler, or robot, RO for moving substrates between the various devices and the loading bay LB of the lithographic apparatus LA. The aforementioned devices are generally referred to collectively as the track and are controlled by a track control unit TCU so as to process substrates according to the appropriate recipe. Typically, substrates are taken in at one of the ports I/O1 or I/O2, cooled on a chiller plate CH, coated with resist using a spin coater SC, given a pre-exposure bake on a bake plate BK to drive off excess solvent in the resist and cooled again before being exposed by the lithographic apparatus LA. After exposure, the substrates are subjected to a soft bake, cooled, developed, hard baked and cooled again before being output via one of the ports.

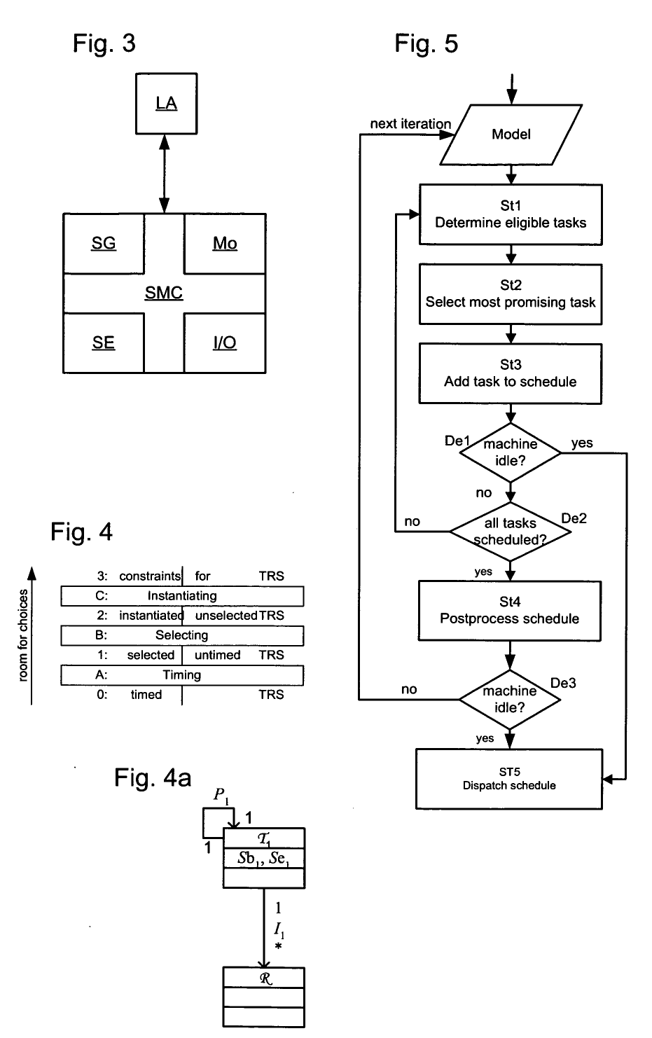

Co-ordination of the mechatronic systems of the lithographic apparatus LA is the responsibility of supervisory machine control SMC, which is shown in FIG. 3. The supervisory machine control includes a model Mo of the machine (all or part of the lithographic apparatus), an input/output device I/O (e.g. keyboard & screen, removable disk drive or network connection) through which job parameters and other information can be entered, a schedule generator SG (described further below) and a schedule evaluator and optimizer SE. In order to optimize performance, it is desirable that supervisory control is flexible, and that it is able to evaluate ‘what-if’ scenarios before actual execution. As a basis for this evaluation, a model of the system is required. A scheduler, comprising schedule generator SG and evaluator SE, which is embedded in SMC takes care of the evaluation. Below are described a basis of the scheduling problem, a model of the machine and the manufacturing work to be done, and a basic algorithm of an embedded scheduler according to an embodiment of the invention.

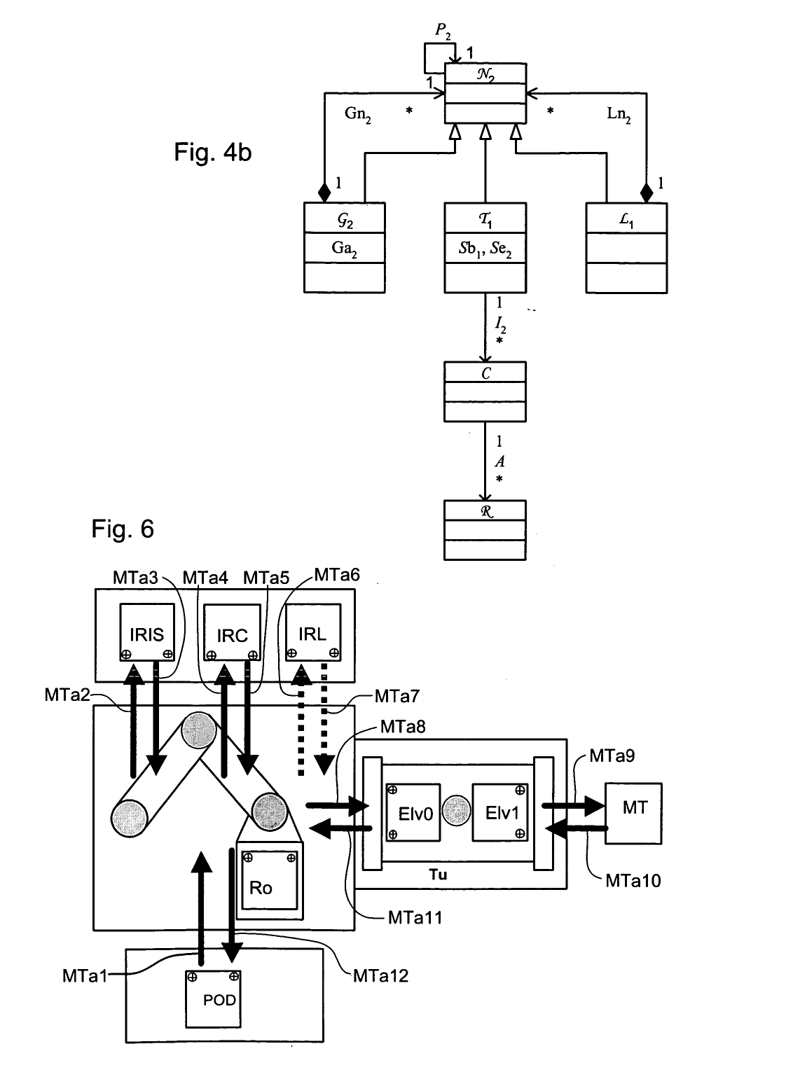

From the supervisory machine control point of view, the machine can be considered as a task resource system (TRS). A manufacturing process can be associated with a task, whereas a mechatronic system can be associated with a resource. Optimization of machine behavior can start from several TRS definition levels, as has been described in N. J. M. van den Nieuwelaar, J. M. van de Mortel-Fronczak, J. E. Rooda, “Design of Supervisory Machine Control”, European Control Conference 2003, which document is hereby incorporated in its entirety by reference. The higher the definition level, the more room there is for choices. By making choices, TRS definitions can be transformed to lower levels, to finally result in temporal machine behavior (TRS definition level 0: timed TRS, see FIG. 4). In the paper “Design of Supervisory Machine Control”, the lower two TRS definition levels (1, 0) and the applicable transformation functionality between them (layer A) are formally described, and the higher definition levels and the issues involved are introduced. Furthermore, some considerations to be taken into account when deciding to either make choices design-time or run-time (by SMC) are given. Finally, an overview of known techniques to support the design of SMC is discussed.

The following description of an embodiment of the invention has two parts. First, the definition level of the starting point of the optimization problem is raised from 1 to 2: an unselected TRS. Second, a solution for the optimization problem is presented that starts from a system definition of class 2, taking into account the technique considerations described in “Design of Supervisory Machine Control”. Important requirements for the approach are extendibility towards definition level 3, and run-time usability in SMC. This approach forms a basis for model-based supervisory control of manufacturing machines according to an embodiment of the invention, which has several advantages compared to the common used state-based control. Using the model, supervisory control can evaluate ‘what-if’ scenarios with respect to control decisions, and schedule tasks in time rather than just one after another. Moreover, as the model enables supervisory control to ‘look ahead’, it is possible to use this predictive information to synchronize with related (parts of) machines that are in another control scope. Furthermore, the approach is flexible, which improves its maintainability.

The optimization problem starting from an instantiated, unselected TRS definition ((D₂) is formally defined below. Let f_{AB}(D₂)=D₀ be the optimization function that performs transformations A and B on D₂ to return the temporal machine behavior D₀. The constraints that have to be satisfied for f_{AB}(D₂) are constructed by combining the constraints of the separate transformations A and B. First, the definitions D₀ and D₁ and the constraints concerning transformation A(f_{A}(D₁)) are summarized, which is an extraction from “Design of Supervisory Machine Control”. Subsequently, the alternatives that are relevant in the application domain of manufacturing machines are analyzed, and based on this analysis D₂ is formulated. After that, the constraints to be taken into account when selecting from the alternatives defined in definition level 2 to reach definition level 1 (transformation B or f_{B}(D₂)) are discussed. Finally, the entire problem f_{AB}(D₂) is defined using the fact that f_{AB}(D₂)=f_{A}(f_{B}(D₂)).

The timing behavior of timed TRS D₀ can be described by a 5-tuple (T₀,R,I₀,τ_{S}_{₀},τ_{F}_{₀}):
T₀ is a finite set whose elements are called tasks.
R is a finite set whose elements are called resources.
I₀: T₀→P(R) is the set of resources that are involved in a certain task.
τ_{S}_{₀},τ_{F}_{₀}:T₀→R⁺ are the start time and the end time of a certain task, which implies that these are the same for all involved resources.

Note that, by convention, the definition level is added to each definition element in subscript. Definition elements which are not level specific have no suffix. Furthermore, note that D₀ can be visualized as a Gantt chart.

The constraint that has to be satisfied for the instances of the definition elements is as follows:
0a: Per resource, there is a chronological sequence of pairs of task start and task finish times.

The timing behavior of a task resource system is induced by physical state transitions of resources. Machine resources are mechatronic systems that have certain performance limitations. Therefore resources have to obey certain behavioral restrictions when executing physical state transitions. Tasks impose start and end states of these physical state transitions, as well as behavioral restrictions of the transition trajectories in between. Furthermore, tasks have to be executed in a certain order. A selected, untimed TRS D₁ can be described by a 6-tuple (T₁,R,I₁,P₁,Sb₁,Se₁):
T₁ and I₁ are equal to T₀ and I₀, respectively.

P₁ ∈ P(T₁×T₁) is the precedence relation between tasks.

Sb₁,Se₁:T₁×R→S give the begin and the end (physical) states of each resource involved in a certain task, where S is the set of all possible physical resource states.

Constraints that have to be satisfied for the instances of the definition elements are as follows:
1a: The sequence of tasks per resource is a chain (matches 0a).
1b: P₁ contains no cycles.
1c: For every resource involved in a task, the begin and end state must be defined.

These definition elements are depicted as a UML class diagram in FIG. 4a.

Transformation A involves timing of the tasks of the untimed, selected TRS definition D₁. Constraints that have to be satisfied for f_{A}((D₁) are as follows:
a1: Nothing changes with respect to tasks and the (involved) resources:
   T₀=T₁, I₀=I₁
a2: By convention, time starts at 0. Furthermore, the finish time of a task equals its start time plus its duration:
   ∀ t:t ∈ T₁:τ_{S}_{₀}(t)≧0 \hat{ } τ_{F}_{₀}(t)=τ_{S}_{₀}(t)+τₜ_{₀}(t).
a3: For subsequent tasks it holds that the start time of the succeeding task is greater than or equal to the finish time of the preceding task:
   ∀ t,t′:(t,t′) ∈ P₁:τ_{S}_{₀}(t40 )≧τ_{F}_{₀}(t).
a4: To match the states of subsequent tasks on the same resource, setup state transitions of the resource might be necessary. In these cases the start time of the succeeding task is greater than or equal to the finish time of the preceding task plus the duration of the setup resource state transition between the tasks:
   ∀ t,t′,r:(t,t′) ∈ P₁′ \hat{ } r ∈ I₁(t) ∩ I₁(t′):τ_{S}_{₀}(t′)≧τ_{F}_{₀}(t)+τᵣ_{₀}(r,Se₁(t,r),Sb₁(t′,r)),
   where:
P₁′ ⊂ P₁ is the union of all resource task chains.
τₜ_{₀}:T₁→R⁺ gives the duration of a certain task, taking into account the behavioral restrictions imposed by the task as well as the resources involved with the task.
τᵣ_{₀}:R×S×S→R⁺ gives the duration of a resource setup from some state to another state, taking into account the behavioral restrictions imposed by the resource. For further information on τₜ_{₀} and τᵣ_{₀}, see “Design of Supervisory Machine Control” referred to above.

In complex manufacturing machines, alternatives exist with respect to different elements of D₁. First of all, alternatives exist concerning precedences. Whereas the precedence relation in level 1 ensures chains of tasks per resource, this order is not essential. What is essential is that the tasks involved in the manufacturing process of the different manufacturing entities are performed in the right order per manufacturing instance. Furthermore, there is a mutual exclusive constraint: a resource can perform only one task at a time. Given the essential order imposed by the manufacturing process and the mutual exclusive constraint, several possibilities exist to interweave the different manufacturing entities. The alternatives with respect to precedences are analogous to the job shop scheduling (JSS) problem described in M. Pinedo, “Scheduling: Theory, Algorithms, and Systems”, Prentice Hall, Englewood Cliffs, (1995).

Second, alternatives exist concerning involved resources. In some cases, multiple resources of the same kind are present in a machine. Several resources can be chosen from to involve in or allocate to a certain task. This is also the case in the generalized job shop scheduling problem described in M. Wennink, “Algorithmic Support for Automated Planning Boards”, PhD Thesis, Eindhoven University of Technology, (1995).

Finally, alternatives exist concerning tasks. This is implied by the fact that in some cases multiple tasks exist in a system that have an equivalent effect on the manufacturing process. For instance, multiple paths to transport material from one place to another, or a set of (m) tasks of which only a subset (n) has to be selected. To determine the required expressiveness of the elements in D₂ to outline the room for choices concerning tasks, some examples from a substrate scanner are analyzed. Regarding the exposure scanning of dies, a 1 out of 2 expressivity is required: a die can be exposed (scanned) in two directions, of which one must be selected. This is analogous to the Rural Postman Problem: n out of m, in which n=1, and m=2 (see E. L. Lawler, J. K. Lenstra, A. H. G. Rinnooy Kan, D. B, Shmoys. “The Traveling Salesman Problem: A Guided Tour of Combinatorial Optimization”, Chichester, Wiley-Interscience, pp. 177-178, (1985)). Regarding the measuring of marker pairs on a substrate, the requirements are more difficult. From the (m) marker pairs on a substrate, a minimum number (n) must be measured. A marker pair consists of several markers, each requiring a measure scan task in either direction (n₀=1). In this case the task selection can be defined as a selection out of m, in which the number n₀ of selected marker pairs must be an allowed number, and in which for all markers in the selected marker pairs one scan task is selected. From this, it can be concluded that nesting is needed (n₀ in n) and that the allowed number of alternatives can be more than one number (n ∈ P(N⁺)). Furthermore, a complex machine may contain buffer places. At certain points in the manufacturing process, it is possible to buffer a manufacturing entity. To define this possibility in an intuitive way, it must be possible to describe the fact that also no buffering is allowed, or: 0 can also be an allowed number (n ∈ P(N)).

To outline the room for alternatives to select from, literature is followed as much as possible. To outline essential precedences, it is not necessary to introduce a new definition element. Similar to JSS, the precedence element is stripped with respect to level 1 to contain only the essential precedence relations: P₂ ⊂ P₁. The stripped precedence instances P₁\P₂ concern the scheduled interweaving of the instances that are the result of selection B. The precedence alternatives are outlined by P₂ together with a constraint assuring mutual exclusiveness. To outline resource involvement, an additional definition element called capability is introduced: C, similar to generalized JSS. The involvement function is changed to indicate which capabilities are involved with a certain task: I₂:T₂→P(C). An additional availability function A: C→P(R) is introduced to describe which resources are available for a certain capability. The resource involvement selection implies selection of one available resource for each involved capability.

To outline the required room for alternatives with respect to tasks, literature can not be followed. Therefore, reasoning is started at the basics. In general, tasks and their precedence relation can be visualized by a graph of type ‘activity on node’. For the purpose of modeling selection alternatives concerning tasks, a more general node element N₂ is introduced. Equivalent alternatives can consist of a cluster of nodes (nesting). To identify such clusters, an additional node type cluster (L₂) is introduced. Function Ln₂: L₂→P(N₂) is introduced to define which nodes belong to which cluster. Furthermore, it is possible that multiple numbers of alternative nodes are allowed to be selected, including the possibility to select none of them. To be able to define which nodes belong to such a group of alternatives, a node type group is introduced: G₂. Function Gn₂ is introduced to define which nodes are in which group, whereas function Ga₂ is introduced to define how many of these nodes are allowed to be selected. The newly introduced definition elements, together with some selection constraints outline the room for selections with respect to tasks. The resulting model can express [n₁out of m] or [n₂out of m], etc., (aggregates of) tasks, which is abbreviated to [{n₁, n₂, . . . nₓ} out of m].

Summarizing this analysis, an instantiated, unselected TRS D₂ can be defined by a 14-tuple (T₂,L₂,G₂,N₂,R,C,I₂,A,P₂,Ln₂,Gn₂,Ga₂,Sb₂,Se₂):
T₂ is a finite set whose elements are called tasks.
L₂ is a finite set whose elements are called clusters.
G₂ is a finite set whose elements are called groups.
N₂ is a finite set whose elements are called nodes and is a generalization of the model elements mentioned earlier: N₂=T₂ ∪ L₂ ∪ G₂.
R is a finite set whose elements are called resources.
C is a finite set whose elements are called capabilities.

I₂:T₂→P(C) gives the set of capabilities that are involved with a certain task.

A:C→P(R) gives the set of resources that are available for a certain capability.

P₂ ∈ P(N₂×N₂) is the precedence relation between nodes.

Ln₂:L₂→P(N₂) gives the set of nodes that are in a certain cluster.

Gn₂:G₂→P(N₂) gives the set of nodes (alternatives) that a group consists of.

Ga₂:G₂→P(N)) gives the allowed numbers (including 0) of nodes to be selected from a group.

Sb₂, Se₂:T₂×C→S give the begin and the end (physical) states of each capability involved in a certain task.

These definition elements are depicted as a UML class diagram in FIG. 4b.

Constraints that have to be satisfied for the instances of the model elements are as follows:
2a: P₂ contains no cycles (see 1b).
2b: For every capability involved in a task, the begin and the end states must be defined (see 1c).
2c: There is no group that has only 0 as allowed number of selected nodes: [symbol]
   g:g ∈ G₂:Gn₂(g)={0}.
2d: Nodes which are element of a group have no preceding or succeeding nodes:
   ∀ g,n:g ∈ G₂,n ∈ Gn₂(g):( [symbol] n′:n′∈ N₂:(n′,n) ∈ P₂ [symbol] (n,n′) ∈ P₂.
2e: Precedences do not cross group boundaries.

By making choice B, a TRS definition of class 2 is transformed to a TRS definition of class 1. One of the choices has to do with selection from alternatives with respect to tasks. We define a node to be selected if at least one of the tasks that is in it is selected. Let N₁ be the set of selected nodes, then the constraints for f_{B}(D₂) can be formulated as follows:
b1: The sequence of selected tasks per resource is a chain (equals 1a).
b2: For each selected task, an available resource must be selected for each involved capability:
   ∀ t,r,c:t ∈ T₁,r ∈ I₁(t),c ∈ I₂(t):r ∈ A(c).

The begin and end state definition is copied from the capability to the selected resource.
b3: Precedence relations are inherited.
∀ n,n′,t,t′:n,n′∈ N₁,t,t′∈ T₁,t ∈ TinN(n),t′ ∈ TinN(n′),(n′,n) ∈ P₂:(t′,t) ∈ P₁,
where function TinN(n) returns all tasks in a certain node n:

$$TinN ( n ) = \{ \begin{matrix}\{ n \} & if n ∈ {T}_{2} \\ ( ⋃ {n}^{′} : {n}^{′} ∈ {Ln}_{2} ( n ) : TinN ( {n}^{′} ) ) & if n ∈ {L}_{2} \\ ( ⋃ {n}^{′} : {n}^{′} ∈ {Gn}_{2} ( n ) : TinN ( {n}^{′} ) ) & if n ∈ {G}_{2}\end{matrix}$$
b4: Any node that is not part of another node must be selected, except for groups for which choosing nothing is allowed (‘nilgroups’):
   ∀ n,l,g:n ∈ N₂,l ∈ L₂,g ∈ G₂,n ∉Ln₂(l),n ∉ Gn₂(g),n ∉ {g′∈ G₂|0 ∈ Ga₂(g′)}:n ∈ N₁
b5: Any node that is part of a selected cluster must be selected, except for nilgroups:
   ∀ l:l ∈ L₂ ∩ N₁:{n ∈ Ln₂(l)|n ∉ {g═∈ G₂|0 ∈ Ga₂(g′)}} ⊂ N₁
b6: In case nilgroups are not considered, the constraint for groups would be that the number of selected nodes that are part of a selected group must be allowed: ∀ g:g ∈ G₂ ∩ N₁:#(Gn₂(g) ∩ N₁) ∈ Ga₂(g). The prsence of unselected nilgroups in a group relaxes this constraint somewhat, as unselected nilgroups may either or not be counted regarding the allowed number of selected nodes in a group. Knowing this, the constraint can be described as follows:
   ∃a ∈ Ga₂(g):#(Gn₂(g) ∩ N₁)≦a≦#(Gn₂(g) ∩ N₁)+#{g′ ∈ G₂ ∩ Gn₂(g)|0 ∈ Ga₂(g′)\hat{ } g′∉ N₁}

To complete the formal definition of the optimization problem, a goal function f_{g}:D₀→R is defined, that quantifies the quality of a certain temporal behavior. Examples of factors that play a role in this function are total system duration and number of tasks. Furthermore, two sets of valid functions for f_{A} and f_{B} are introduced, F_{A}, and F_{B}, respectively. With this, the optimization problem can be described as follows:
max f_{A}, f_{B}:f_{A} ∈ F_{A}, f_{B} ∈ F_{B}:f_{g}(f_{A}(f_{B})D₂)) (1.1)

In a practical embodiment of the invention, the run-time usability requirement has important consequences. To avoid the machine being idle while waiting for its controller to compute ‘optimal’ schedules, the algorithm according to an embodiment of the invention is such that tasks can be dispatched to start execution with very small time delays. To achieve this, the schedule is determined in a constructive way, which means from the begin to the end in schedule time. This approach is also safe with respect to extendibility towards handling a TRS definition of level 3. Furthermore, it is possible to dispatch a partial schedule after each task that is added to it. To ensure that the dispatched schedule is an acceptable one, heuristic filters are used to direct the scheduling choices involving choice B. Note that if the algorithm is interrupted to dispatch the schedule, sub-optimal schedule solutions are taken for granted in favor of just getting the machine to work, and non-repetitive behavior might result. Moreover, heuristic filters can be configured such that behavior of a state-based control architecture is copied, which is convenient for software migration purposes. Concerning choice A, the duration of tasks and setup resource state transitions between tasks is determined using dedicated mathematical functions for efficiency and embedability in SMC. Furthermore, the default heuristic of the approach with respect to selection A is to schedule a selected task ‘As Soon As Possible’ ASAP, resulting in an ‘active’ schedule. For memory efficiency, a compact data structure is applied to store the result of selection B that is also compatible with the constructive and ASAP scheduling heuristic of selection A: a heap of pieces (see G. X. Viennot,. “Heaps of Pieces, I: Basic Definitions and Combinatorial Lemmas,” Combinatoire Enumerative, Labelle and Leroux, Eds., no. 1234 in Lect. Notes in Math., New York: Springer, pp. 321-350,(1986)). A piece defines a selected task and the selected involved resources, whereas the sequence of pieces in the heap defines the selected precedence relation. Depending on the goal function, a post-processing step is done with respect to selection A to postpone some tasks in order to improve the schedule. Subsequently, other choices with respect to selection B are considered. Taking the run-time aspect into account, the approach explores other alternatives at the beginning of the schedule first, as these tasks will be dispatched first. In FIG. 5, the approach is depicted in a flow chart. Summarizing, the approach is a constraint-guided heuristic search algorithm (see M. Pinedo. “Scheduling: Theory, Algorithms, and Systems” referenced above) with a lot of ‘escape’ points to dispatch work early if desired.

The first step of the method is to determine eligible tasks (pieces). During transformation functionality B, selected alternatives are stored in a heap of pieces. Piece p describes which task t ∈ T₂ is selected, and the selected resources rr ⊂ R₂ involved: p ∈ T₂×P(R₂). The sequence of pieces in the heap h ∈ P((T₂×P(R₂))*) describes the selected precedence relations in addition to the precedence relations in P₂ (intrinsically satisfying constraint b1). If no alternatives with respect to tasks are taken into account, considering a heap h containing passed (=selected up to then) tasks tₚ ⊂ T₂, a next piece p consisting of task t and involved resources rr is eligible to form an extended heap hp if and only if:
the predecessors of t are in pieces of heap h, and t is not:
   Et(h)={t ∈ T₂\tₚ|(∀ t′:(t′,t) ∈ P₂:t′ ∈ tₚ} (1.2)
constraint b2 is satisfied concerning rr:
   Er(t)={rr ⊂ R|(∀ r,c:r ∈ rr,c ∈ I₂(t):r ∈ A(c))} (1.3)
The set of eligible next pieces for sequence h can be defined as follows:
   E(h)={(t,rr)|t ∈ Et(h) \hat{ } rr ∈ Er(t)} (1.4)

The set of feasible heaps H ⊂ P((T₂×P(R₂))*) can be defined by induction as follows:
ε ∈ H (1.5)
ε ∈ H \hat{ } p ∈ E(h) [symbol] hp ∈ H (1.6)
In (1.5), ∈ denotes the empty heap.

Considering the alternatives with respect to tasks, function Et(h) must be extended. During the selection process, tasks that are not selected and will not be selected anymore are called ‘bypassed’. After the selection process, the set of bypassed tasks equals T₂\T₁. Function Et(h) needs to consider only tasks that are neither passed nor bypassed. For the tasks that are neither passed nor bypassed, the predecessor relation must be checked. In case no alternatives with respect to tasks are considered, all predecessors must be in the heap (see Equation 1.2). This condition is relaxed in case of predecessors of type group; all (possibly inherited, see constraint b3) predecessors must be ‘succeedable’.

Let function anc: N₂→P(N₂) be a recursive function that determines the ancestors of a node, which are those nodes in which a node n is contained:
anc(n)=(∪n′:n′∈ N₂\T₂ \hat{ } n ∈ Gn₂(n′) ∪ Ln₂(n′):{n′} ∪ anc(n′)) (1.7))

This recursion is finite as the nodes have a hierarchical structure, which is explored upwards only in this function.

Let function succ: N₂→P(N₂) be a function that determines the successors of a node n:
succ(n): (∪n′:n′∈ N₂ \hat{ } (∃n″:n″∈ anc(n) ∪ {n}:(n″,n′) ∈ P₂):{n′}) (1.8)

A task is succeedable when it is passed, and a cluster is succeedable when all nodes in it are succeedable. The non-succeedable nodes of a succeedable group may contain no passed tasks. Furthermore, if none of the nodes of a group is succeedable whereas zero is an allowed number, a group is succeedable when all of its predecessors are succeedable. In other cases, a group is succeedable when the (non zero) number of succeedable nodes of it is an allowed number.

Let ns: N₂→B be a recursive function that determines whether a node n is succeedable:

$$ns ( n ) = ( n ∈ {T}_{2} ⋀ n ∈ {t}_{p} ) ⋁ ( n ∈ {L}_{2} ⋀ ( ∀ {n}^{′} : {n}^{′} ∈ {Ln}_{2} ( n ) : ns ( {n}^{′} ) ) ) ⋁ ( n ∈ {G}_{2} ⋀ ( ∀ {n}^{′} : {n}^{′} ∈ {Gn}_{2} ( n ) ⋀ ⫬ ns ( {n}^{′} ) : ( ∀ t : t ∈ {T}_{2} ⋀ n ∈ anc ( t ) : t ∉ {t}_{p} ) ) ⋀ ( ( ∄ {n}^{′} : {n}^{′} ∈ {Gn}_{2} ( n ) ⋀ ns ( {n}^{′} ) ) ⋀ ( 0 ∈ {Ga}_{2} ( n ) ) ) ⋀ ( ∀ {n}^{′} : {n}^{′} ∈ {N}_{2} ⋀ ( {n}^{′} , n ) ∈ {N}_{2} ⋀ ( {n}^{′} , n ) ∈ {P}_{2} : ns ( {n}^{′} ) ) ⋁ ( ( ( ∃ {n}^{′} : {n}^{′} ∈ {Gn}_{2} ( n ) ⋀ ns ( {n}^{′} ) ) ⋁ ( 0 ∉ {Ga}_{2} ( n ) ) ) ⋀ ( \vert \{ {n}^{′} \vert {n}^{′} ∈ {Gn}_{2} ( n ) ⋀ ns ( {n}^{′} ) \} \vert ∈ {Ga}_{2} ( n ) ) ) ) \qquad ( 1.9 )$$

This recursion is finite as the nodes have a hierarchical structure which is explored downwards only, and precedences have no loops and are explored backwards only. The set of succeedable nodes, nₛ, can be defined as follows: nₛ={n ∈ N₂|ns(n)}.

Let nᵢ be the set of initiated nodes. A node is initiated if it is not succeedable and contains a passed task. This set can be defined as follows:
nᵢ→(∪n:n ∈ N₂\nₛ \hat{ } (∃t:t ∈ tₚ:n ∈ anc(t)):{n}) (1.10)

A task is bypassed when it is not passed and when it is in a (node of a) group that is not succeedable or initiated whereas the maximum number of nodes of the group is succeedable or initiated, or if any succeeding node of it is succeedable. The set of bypassed tasks, t_{b}, can be defined as follows.

$${t}_{b} = \{ t ∈ {T}_{2} \backslash {t}_{p} \vert ( ∃ g : g ∈ {G}_{2} : {Gn}_{2} ( g ) ⋂ ( anc ( t ) ⋃ \{ t \} ) \backslash ( {n}_{s} ⋃ {n}_{i} ) ⋀ \vert {Gn}_{2} \\ ( g ) ⋂ ( {n}_{s} ⋃ {n}_{i} ) \vert = max ( {Ga}_{2} ( g ) ) ) ⋁ ( ∃ {t}^{′} ∈ {t}_{p} : ( \{ {t}^{′} \} ⋃ anc ( {t}^{′} ) ) ⋂ succnil ( t ) \neq ∅ ) \} \qquad ( 1.11 )$$

Where function succnil: T₂→P(N₂) determines the successors of a task t, including the successors of succeeding nilgroups:
succnil(t)=succ(t) ∪ (∪n:n ∈ (succ(t) ∩ G₂) \hat{ } 0 ∈ Gn₂(n): succnil(n))

Using this, function Et(h) when considering alternatives with respect to tasks can be defined as follows:
Et(h)={t ∈ T₂\tₚ\t₆|(∀ n,n′:n ∈ anc(t)\hat{ } (n′,n) ∈ P₂: n′∈ nᵢ)} (1.12)

The second step of the method is application dependent but the third step can be described generally.

An ‘As Soon As Possible’ (ASAP) heuristic for the choice concerning timing can be associated with an intuitive interpretation, namely that of a heap of pieces (see G. X. Viennot, “Heaps of Pieces, I: Basic Definitions and Combinatorial Lemmas,” Combinatoire Enumerative, Labelle and Leroux, Eds., no. 1234 in Lect. Notes in Math., New York: Springer, pp. 321-350, (1986)). Timing behavior of a TRS can be visualized using a Gantt chart. When a Gantt chart is turned 90° counter-clockwise, the resource occupation by tasks can be interpreted as a heap of pieces p ∈ T₂×P(R). The first element of this tuple p₀ equals the considered task, whereas the second element p₁ equals the resources involved with this task: p=(t, I₁(t)). Resources can be associated with the slots on the horizontal axis, whereas (task duration) time is represented on the vertical axis. Tasks are represented by rectangular pieces. The task duration τₜ_{₀} is represented by the height of a rectangle, whereas the involved resources are represented by its ‘width’. The ‘ASAP’ heuristic can be associated with pieces falling onto each other under the influence of ‘gravity’.

The upper contour of a heap is associated with the time until which the resources are occupied by the pieces in the heap. It is defined as the R-dimensional row vector u_{H}(h), where u_{H}(h,r) is the height of the heap on slot r. The upper contour state is defined as the R-dimensional row vector u_{Hs}(h), where u_{Hs}(h,r) is the (physical) state of resource r at time u_{H}(h,r).

The horizontal ground convention (see constraint a2), which can be associated with time starting at 0, yields:
u_{H}(ε)=(0, . . . ,0) (1.13)

The upper contour of heap hp that results after piling up a piece p on top of a heap h is equal to the finish time of task t for the resources that are occupied by t and equal to the upper contour of h for the other resources:

$${u}_{H} ( hp , r ) = \{ \begin{matrix}{τ}_{{F}_{0}} ( p .0 , h ) & if r ∈ p .1 \\ {u}_{H} ( h , r ) & if r ∉ p .1\end{matrix} \qquad ( 1.14 )$$

The upper contour state of heap hp that results after piling up a piece p on top of a heap h is equal to the end state of task t for the resources that are occupied by t and equal to the upper contour state of h for the other resources:

$${u}_{Hs} ( hp , r ) = \{ \begin{matrix}{Se}_{1} ( p .0 , h ) & if r ∈ p .1 \\ {u}_{Hs} ( h , r ) & if r ∉ p .1\end{matrix} \qquad ( 1.15 )$$

The finish time of a task t is obtained by adding its duration to its start time (see constraint a2):
τ_{F}_{₀}(t,h)=τ_{S}_{₀}(t,h)+τᵣ_{₀}(t) (1.16)

The start time of a task t associated with piece p being piled upon top of a heap h is influenced by two components: by its preceding tasks (see constraint a3) on the one hand and by the setup state transitions of the involved resources (see constraint a4) on the other. Note that this precedence constraint is an extension of that described in S. Gaubert and J. Mairesse, “Task Resource Models and (max, +) Automata,” in Idempotency, Cambridge, U.K. Cambridge University Press, pp. 133-144, 1998. It can be determined by taking the highest value of either the highest finish time of its preceding tasks, τ_{S}_{₀ₚ}(t,h), or of the highest part of the upper contour of the heap h beneath the piece after setup of the involved resources, τ_{S}_{₀ᵣ}(t,h):
τ_{S}_{₀}(t,h)=max(τ_{S}_{₀ₚ}(t,h),τ_{S}_{₀ᵣ}(t,h)) (1.17)

Regarding preceding tasks, the start time of task t equals the maximum finish time of the passed tasks that precede any node n that t is in:
τ_{S}_{₀}(t,h)=max t′:t′∈ (∪n:n ∈ N₂ \hat{ } t ∈ (TinN(n): tpp(n,h))):τ_{F}_{₀}(t′,h) (1.18)
where function tpp:N₂×(T₂×P(R))*→P(T₂) determines all passed tasks preceding a node. If any of these predecessors is an unselected nilgroup, the passed tasks in the predecessors of that nilgroup must be retrieved. Because of this, the function is recursive and is defined as follows:

$$tpp ( n , h ) = \{ \begin{matrix}\{ \} & if ∃ {n}^{′} : ( {n}^{′} , n ) ∈ {P}_{2} \\ ⋃ {n}^{′} : ( {n}^{′} , n ) ∈ {P}_{2} : \{ \begin{matrix}{t}_{p} ⋂ TinN ( {n}^{′} ) & if ∃ {t}^{′} : {t}^{′} ∈ {t}_{p} ⋂ TinN ( {n}^{′} ) \\ tpp ( {n}^{′} , h ) & if ∄ {t}^{′} : {t}^{′} ∈ {t}_{p} ⋂ TinN ( {n}^{′} )\end{matrix} & if ∃ {n}^{′} : ( {n}^{′} , n ) ∈ {P}_{2}\end{matrix} \qquad ( 1.19 )$$

Regarding resource setup, the start time of a task t can be obtained as follows:

$${τ}_{{S}_{0} r} ( t , h ) = {max}_{r ∈ {I}_{1} ( t )} ( {u}_{H} ( h , r ) + {τ}_{{r}_{0}} ( r , {u}_{Hs} ( h , r ) , {Sb}_{1} ( t , r ) ) \qquad ( 1.20 )$$

The above general situation can be applied to a dual stage lithographic apparatus as described above. By way of an example, 3 lots each of 5 substrates of a double exposure recipe are considered. For each lot, different masks are needed: masks 1 and 2 for the first lot, masks 3 and 4 for the second lot and masks 5 and 6 for the third lot. Each substrate consists of 171 dies of size 26×13 mm², in which the 13 mm is in the scanning direction. Prior to the exposure of the dies, each substrate must be measured. This measuring step involves measurement of alignment marker pairs. 25 alignment marker pairs are placed on each substrate, of which at least 16 pairs must be measured in either direction of each marker to reach the required minimum manufacturing accuracy.

For the purpose of this example, only the selection of tasks and their order is concerned.

Alternatives lie in the following areas:
1. In which order and direction to execute the exposures of the dies of each substrate,
2. Which marker measuring tasks to execute in which order,
3. Which mask handling tasks to execute in which order.

In FIG. 6, which depicts the mask handling arrangements of the lithographic apparatus of FIG. 1 in more detail, the sequential mask handling tasks that can be executed for one mask are indicated using an arrow, and are labeled by their sequence number. The dotted arrows concern usage of a buffer (tasks MTa6 and MTa7), which is optional. Each resource is denoted by a square.

For illustration, the timing behavior resulting from two different settings for the heuristic filters is described.

The description of the first setting, setting I, is as follows:
1. The exposure sequence is a horizontal meander.
2. The minimum number (16) of marker pairs is measured.
3. Preprocessing of masks is started as soon as possible. If masks can not go through to the mask stage, they are put in the buffer (IRL).

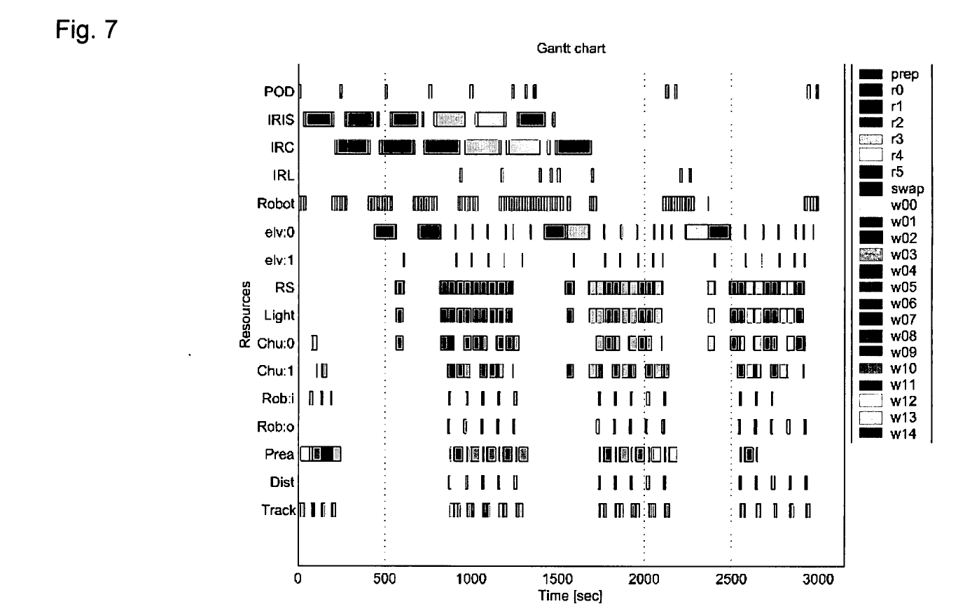

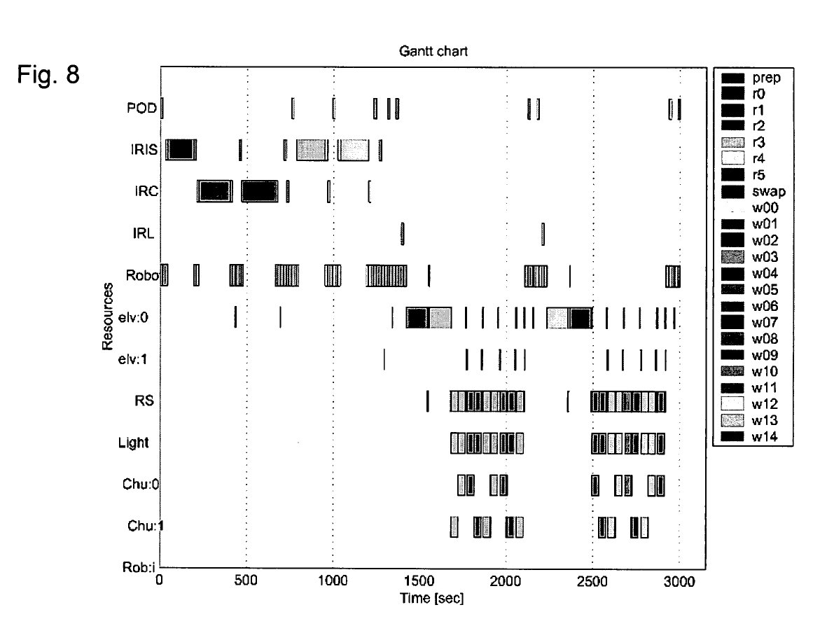

In FIG. 7, the ASAP time behavior for setting I is depicted in a Gantt chart. In this chart, tasks are shaded/colored per substrate or mask, exposure tasks get the shade/color of the mask. In FIG. 8, the critical path of the time behavior is depicted in a Gantt chart.

The description of the second heuristic setting, setting II, is as follows:
1: The exposure sequence is a vertical meander.
2: All marker pairs (25) are measured.
3: Preprocessing of masks is started only if less than 4 preprocessed masks are available for coming exposures. If the robot can choose to either put a mask on the turret or start preprocessing a next mask, it chooses to put the mask on the turret. Masks are put in the IRL buffer after preprocessing only if they have to wait and the coming lot requires another mask that is not preprocessed yet.

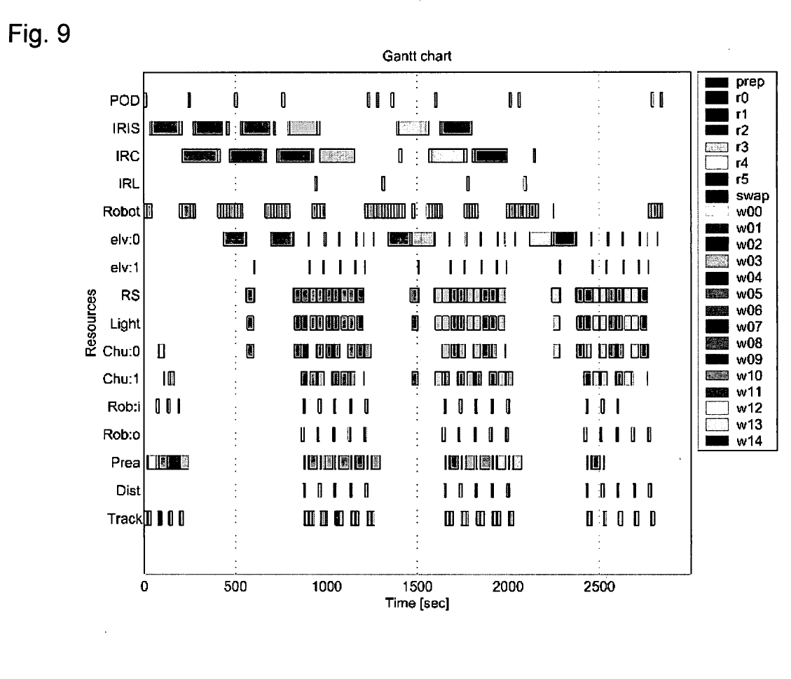

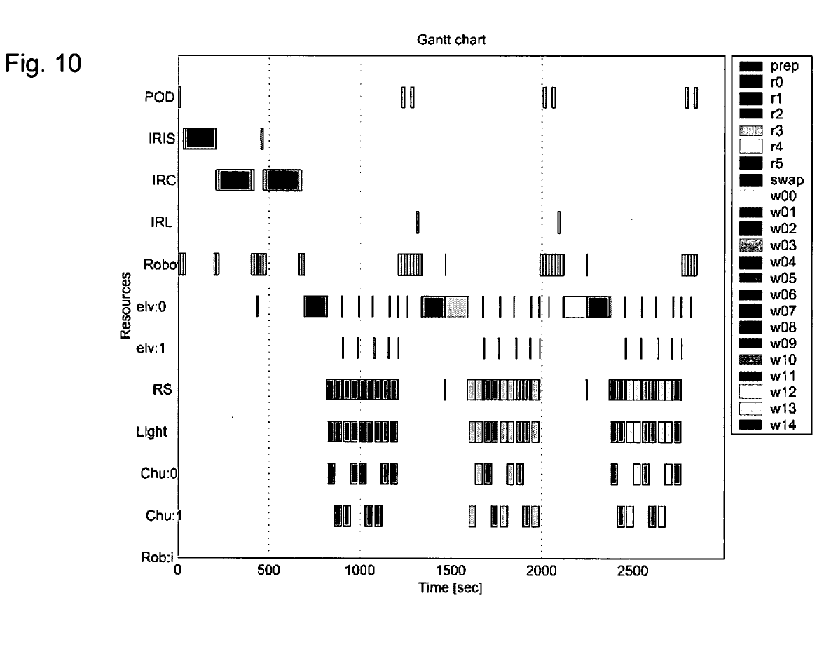

In FIG. 9, the resulting time behavior using setting II is depicted in a Gantt chart. The time needed for manufacturing the three lots is decreased by more than 5% compared to setting I. Half of this is caused by the changed exposure sequence that itself decreased its duration by about 10%. The other half is caused by changed mask handling. As a side effect, better product quality is achieved as more marker pairs are measured. This does not cost any time, as measuring still is not on the critical path, as can be seen in FIG. 10.

An embodiment of the present invention therefore provides a formal basis for model-based supervisory control of manufacturing machines starting from an instantiated, unselected TRS definition. To define the TRS behavior optimization problem formally, the choice making functionalities A and B are regarded as transformation functions. The same goes for the quantification of the quality of the behavior resulting from the choices made, which is done using a goal function. The constraints that have to be satisfied for transformations A and B are defined mathematically. With this, the behavior optimization problem is defined as the maximum value of the goal function for which the constraints concerning transformations A and B are satisfied.

An instantiated, unselected TRS in the domain of complex manufacturing machines leaves room for choices (selection B) with respect to tasks, resources and task order. To define the alternatives to choose from, the generalized JSS approach (see “Algorithmic Support for Automated Planning Boards” referenced above) is followed concerning alternatives with respect to resources and task order, whereas a new approach is developed concerning alternatives with respect to tasks. This approach is more expressive than previous approaches.

Choice functionality A and B are combined in an optimization approach that is suited for run-time application in supervisory machine control. The basis of the approach is a top-down iterative heuristically filtered beam search algorithm and that is coupled with the available search time to combine good behavior quality with little control overhead. The algorithm is extendable for machine-specific issues, which can be defined as additional selection constraints.

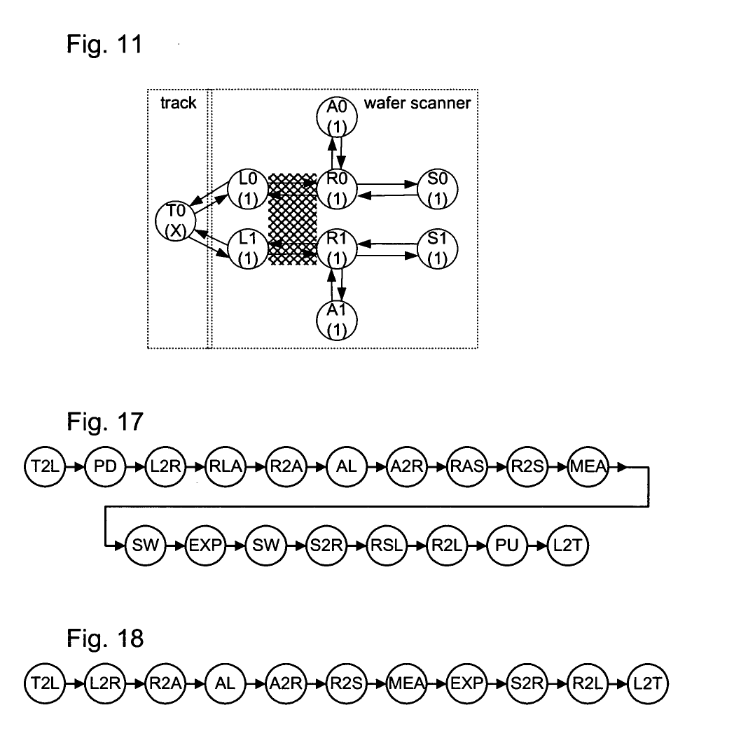

A second embodiment of the invention is applied to a lithographic apparatus employing extreme ultraviolet (EUV) radiation in the projection beam. As this radiation is absorbed by air, exposure must take place in vacuum, whereas the apparatus resides in atmospheric pressure. To bring the substrates from atmospheric pressure to vacuum two load locks L0, L1 are provided. To transport the substrates between the different subsystems two robots R0, R1 are provided. A schematic layout of the apparatus is depicted in FIG. 11.

In FIG. 11, the parallel mechatronic systems—track T0, load locks L0, L1, robots R0, R1, aligners A0, A1 and substrate tables S0, S1 (also referred to below as stages)—considered are depicted by a circle, and the possible transport paths are depicted by arrows. Each mechatronic system (except the track) can carry only one substrate, which is depicted between brackets. The tight layout of the apparatus makes it possible for the robots to collide if they both move from or to a lock, which is depicted by the cross-hatched area. The apparatus is a dual-stage apparatus with separate measure and expose stations (not shown in FIG. 11). In the measure station, substrates can be loaded onto and unloaded from a substrate table at their load and unload position, respectively. Each resource can reach a limited number of states.

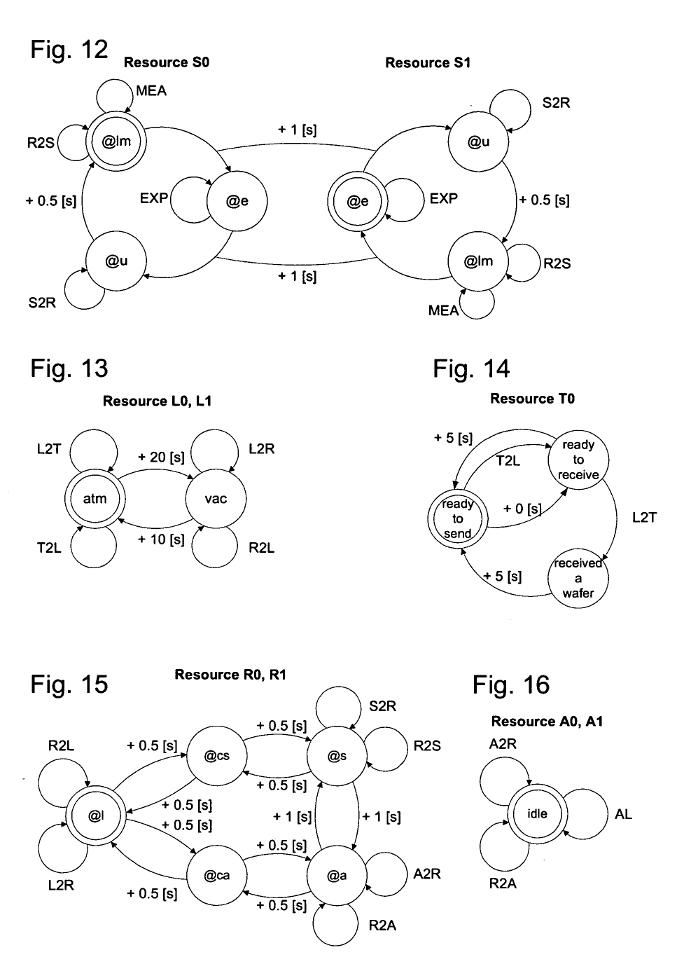

The state-transition diagrams or automata of the different mechatronic systems are shown in FIGS. 12 to 16. In these Figures, the initial state is denoted by an extra circle, and transitions are labeled with a time duration or a task name, which will be explained later. Switching of areas of the tables must be done synchronously to avoid collision of the substrate stages: chuck swap. This is depicted by the dashed connections between the diagrams of the two tables in FIG. 12. As an example, a work to be scheduled concerns a typical batch (lot) of 15 substrates.

As discussed earlier, a scheduling problem can be associated with an instantiated, unselected TRS definition (level 2) in FIG. 4. A job shop scheduling problem can be defined by a 6-tuple (T₂, R, I₂, P₂, Sb₂, Se₂) in which:
T₂ is a finite set whose elements are called tasks.
R is a finite set whose elements are called resources.
I₂:T₂→(P)R gives the resource that is involved in a certain task.
P₂ ⊂ T₂×T₂ is the precedence relation between tasks.
Sb₂,Se₂:T₂×R→S give the begin and the end (physical) state of the resource involved in a certain task.

Note that, by convention, the definition level is added to each definition element in subscript. Definition elements which are not level specific have no suffix.

Constraints that have to be satisfied for the instances of the definition elements are as follows:
2a P₂ contains no cycles.
2b For every resource involved in a task, the begin and the end state must be defined.

However, in a complex machine multiple resources can exist which all are capable of the same work. Furthermore, some tasks involve synchronous transitions of multiple resources. As this can also be the case in job shops, the job shop scheduling problem has been generalized to incorporate this issue (see “Algorithmic Support for Automated Planning Boards ” referenced above)

A generalized job shop scheduling problem can be defined by a 8-tuple (T₂,R,C,I₂,A,P₂,Sb₂,Se₂):
T₂ is a finite set whose elements are called tasks.
R is a finite set whose elements are called resources.
C is a finite set whose elements are called capabilities.
I₂: T₂→P(C), gives the set of capabilities that are involved in a certain task.
A:C→P(R) gives the set of resources that are available for a certain capability.
P₂ ⊂ T₂×T₂ is the precedence relation between tasks.
Sb₂,Se₂:T₂×C→S give the begin and the end (physical) state of each capability involved in a certain task.

Constraints that have to be satisfied for the instances of the definition elements are as follows:
2a P₂ contains no cycles.
2b For every capability involved in a task, the begin and the end state must be defined.

By selecting, which comes down to the assignment of resources to tasks, and determination of the order in which tasks are executed per resource, an unselected TRS is transformed into a selected, untimed TRS, which can be defined by a 6-tuple (T₁,R,I₁,P₁,Sb₁,Se₁):
T₁ is a finite set whose elements are called tasks.
R is a finite set whose elements are called resources.
I₁:T₁→P(R) gives the set of resources that are involved in a certain task.
P₁ ⊂ T₁×T₁ is the precedence relation between tasks.
Sb₁,Se₁:T₁×R→S give the begin and the end (physical) states of each resource involved in a certain task.

Constraints that have to be satisfied for the instances of the definition elements are as follows:
1a The sequence of tasks per resource is a chain.

Constraints that have to be satisfied for the selecting transformation can be formulated as follows:
b1 The sequence of selected tasks per resource is a chain (equals I a).
b2 For each selected task, an available resource must be selected for each involved capability:
   (∀ t,r,c:t ∈ T₁,r ∈ I₁(t),c ∈ I₂(t):r ∈ A(c)).

By timing, a selected, untimed TRS is transformed into a timed TRS, which can be defined by a 5-tuple (T₀,R,I₀,τ_{S}_{₀},τ_{F}_{₀}):
T₀ is a finite set whose elements are called tasks.
R is a finite set whose elements are called resources.
I₀:T₀→P(R) is the set of resources that are involved in a certain task.
τ_{S}_{₀},τ_{F}_{₀}:T₀→R⁺ are the start time and the end time of a certain task, which implies that these are the same for all involved resources.

Furthermore, note that a timed TRS can be visualized as a Gantt chart.

The constraint that has to be satisfied for the instances of the definition elements is as follows:
0a Per resource there is a chronological sequence of pairs of task start and task finish times.

Constraints that have to be satisfied for the timing transformation are as follows:
a1 Nothing changes with respect to tasks and the involved resources:
   T₀=T₁,I₀=I₁
a2 By convention, time starts at 0. Furthermore, the finish time of a task equals its start time plus its duration:
   (∀ t:t ∈ T₁:τ_{S}_{₀}(t)≧0 \hat{ } τ_{F}_{₀}(t)=τ_{S}_{₀}(t)+τₜ_{₀}(t)).
a3 For subsequent tasks, the start time of the succeeding task is greater than or equal to the finish time of the preceding task:
   (∀ t,t′:(t,t′) ∈ P₁:τ_{S}_{₀}(t′)≧τ_{F}_{₀}(t)).
a4 To match the states of subsequent tasks on the same resource, setup state transitions of the resource might be necessary. In these cases, the start time of the succeeding task is greater than or equal to the finish time of the preceding task plus the duration of the setup resource state transition between the tasks:
   (∀ t,t′,r:(t,t′) ∈ P₁′ \hat{ } r ∈ I₁(t) ∩ I₁(t′):τ_{S}_{₀}(t′)≧τ_{F}_{₀}(t)+τᵣ_{₀}(r,Se₁(t,r),Sb₁(t′,r))),
   where:
P₁′ ⊂ P₁ is the union of all resource task chains.
τₜ_{₀}:T₁→R⁺ gives the duration of a certain task, taking into account the behavioral restrictions imposed by the task as well as the resources involved with the task.
τᵣ_{₀}:R×S×S→R⁺ gives the duration of a resource setup from some state to another state, taking into account the behavioral restrictions imposed by the resource. For further information on τₜ_{₀}, and τr_{₀}, see “Design of Supervisory Machine Control” referenced above.

The mapping of the scheduling problem of this embodiment onto the definition of a generalized job shop scheduling problem can be split into two sections: system-dependent elements and work-dependent elements. The system-dependent elements can be defined as follows:

There are 5 capabilities: stage, robot, aligner, lock and track:
C={S,R,A,L,T}.

There are 9 resources: stage0, stage1, robot0, robot1, aligner0, aligner1, lock0, lock1, track0:
R={S0, S1, R0, R1, A0, A1, L0, L1, T0}.

The available resources for each capability are defined as follows:
A={(S,{S0, S1}), (R, {R0, R1}), (A, {A0, A1}), (L, {L0, L1}), (T, {T0})}

To define the work-dependent elements, the sequence of tasks per substrate through the apparatus (life of a substrate) is analyzed. As shown in FIG. 17, first, a substrate is transported from the track into a lock (T2L). Subsequently, the pressure is pumped down (PD), and the substrate is transported onto the robot (L2R). The robot rotates from the lock to the aligner (RLA), places the substrate onto the aligner (R2A), and the alignment takes place (AL). After that, the robot takes the substrate from the aligner (A2R), rotates to the stage (RAS), and places the substrate onto the stage (R2S). On the stage, measurement takes place (MEA), and after stage swap (SW) the substrate is exposed (EXP). Then, the stage swaps to the unload position in the measure area (SW) where the robot takes the substrate from the stage (S2R). The robot rotates to the lock (RSL), and puts the substrate in the lock (R2L). Finally, the lock pumps up the pressure (PU) and the substrate is taken from the lock by the track (L2T). The life of a substrate can be defined by T₂ and P₂, and can graphically displayed by a task graph, as is shown in FIG. 17. A first attempt for the definition of the task graph for the entire batch could be 15 of these identical sequences.

However, when looking closer it appears that some of the tasks in FIG. 17 may be necessary besides the ones in life of a material. For example, if a lock subsequently has to pump down two substrates, it must pump up in between. The same goes for the rotate tasks and the table swap. In job shop scheduling, such tasks are called setups, which implies that they are a consequence of the sequence of regular tasks on the same resource. Depending on the selected sequence of tasks on the same resource, setups are required or not. More particularly: if for some resource the end state of a preceding task does not match the begin state of a succeeding task, a setup is inserted to bridge this gap. This implies that setup tasks can be left out of life of a substrate, as is displayed in FIG. 18.

For one substrate, e.g. substrate 1, the work-dependent elements can be defined as follows:
T₂={W1-T2L, W1-L2R, . . . }
P₂={(W1-T2L, W1-L2R), (W1-L2R, W1-R2A), . . . }
I₂={(W1-T2L, {T, L}), (W1-L2R, {L, R}), (W1-R2A, {R, A}), . . . }
Sb₂={{(W1-T2L, T, rts), (W1-T2L, L, atm)}, {(W1-L2R, L, vac), (W1-L2R, R, @1)}, {(W1-R2A, R, (a), (W1-R2A, A, idle)}, {(W1-AL, A, idle)}, . . . }
Se₂={{(W1-T2L, T, rtr), . . . }

Note that by convention, state names are in lower case whereas task names are in upper case and start with the material associated.

Although the generalized job shop scheduling definition described above forms a good basis for the scheduling problem in a complex machine, some essential constraints are missing to avoid unfeasible schedules. Some of these have to do with material logistics. For instance, whereas material transport is feasible from the track to any of the lock resources of the lock capability, this is not the case from any lock to any robot: logistic flow feasibility. Moreover, if for instance a substrate is transported into one of the locks it must be assured that it is taken from the same lock: logistic flow integrity. Furthermore it must be assured that not too many substrates are in one of the locks at the same time as physical room does not allow for that: material capacity feasibility.

Also resource interference causes additional constraints. Unlike in job shop scheduling, a setup may be constrained to be executed synchronous with other transitions only, for instance the stage swap. On the other hand, multiple setups may be constrained to be executed one at a time as they involve visiting the same hazardous area, for instance robot rotations in front of the locks. Both these complications may be appropriate for part of a setup transition only, for instance the robot rotation from state (a to state @l visits the hazardous area between the intermediate state @ca to state @l only. Therefore, a possibly compound state transition or setup must be decomposed in elementary transitions. The same goes for the state transition of a substrate stage from @e to @lm, which must go via state @u.

Finally, the required nanometer accuracy imposes constraints on some time windows. As the substrate is conditioned on the pre-aligner and the stage but not in between, the time in between should not be more than necessary. This means that tasks A2R and R2S should be executed without delay. Furthermore, the time between exposure and transport to the track (Post Exposure Bake time) should be as constant as possible, to achieve good imaging uniformity.

To ensure feasible machine behavior with respect to material, resources may not be overloaded as they have limited room for material. As material transport tasks also play a role, it must be possible to describe the fact that resources are occupied by material instances and the consequences of tasks for the location of material instances.

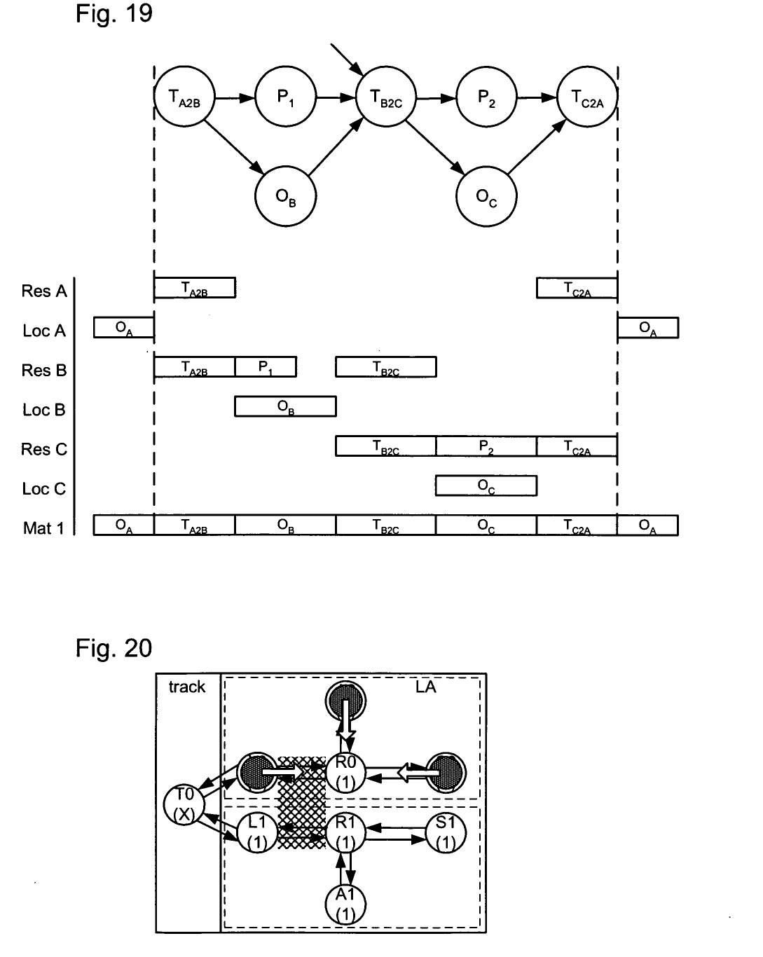

If choices with respect to resources did not play a role, and each resource would have room for one material instance, it would be possible to ensure feasible machine behavior without the introduction of the notion of material. A material instance, as well as the physical material location at a resource could be modeled as a resource. However, as material remains residing at a resource after the physical task, additional ‘material occupation’ tasks are introduced after each physical transport task. These ‘material occupation’ tasks indicate that a resource is occupied by some material instance, and can only be succeeded by a transport task, after which the material resides on another resource. The ‘material occupation’ tasks finish when subsequent transport tasks start. This is illustrated in FIG. 19.

However, if choices with respect to resources do play a role, the approach presented earlier is deficient. In this case, not just any available resources are allowed to be chosen, as the integrity of the logistic flow of the material must be assured. For example: if two resources S1 and S2 of capability S exist, a material that is transported to resource SI must also be transported from S1. This implies that resource S2 is not eligible in this case, even though it is available. To describe the logistic integrity issues in an intuitive way, the notion of material is added to TRS definition level 2.

It is assumed that the logistic (material configuration) effect of a task on the involved material instances is the same for all involved material instances.

The following 5 elements are added to the unselected TRS definition (D₂:
M is a finite set whose elements are called material instances.
Cb₂,Ce₂:T₂→P(C×(P(M)) give the material configuration at the begin and the end of a task as a set of tuples defining each occupied involved capability and the material instances residing on it.
Rm: R→N gives the number of material instances that can reside on a certain resource.
Mf ⊂ R→R represents the physically possible material flow as a set of tuples defining from which resource to which resource material can flow.

Additional constraints that have to be satisfied concerning (D₂:
2-i The capabilities in Cb₂ and Ce₂ must be consistent with I₂:
   (∀ t,c:t ∈ T₂,c ∈ C,c,∈ {cm.0|cm ∈ Cb₂(t) ∪ Ce₂(t)}:c ∈ I₂(t))
2-ii For each capability involved in a task, the logistic effect of the task is the same for all materials involved (for example, a transport of two sets of materials from the same capability to two different other capabilities is not possible in one task): (∀ t:t ∈ T₂:{cm.1|cm ∈ Cb₂(t)})). This constrain implies that only closed systems are considered, which means that material does not enter or leave the system.

Let (P₂ₘ:D₂×M→P(T₂×T₂): be a function describing for each material m ∈ M in a TRS definition D₂ ∈ D₂, a precedence relation between related tasks (the material ‘life’) without redundant edges and with matching capabilities:

$${P}_{2 m} ( D2 , m ) = \{ ( t , {t}^{′} ) \vert ( t , {t}^{′} ) ∈ {P}_{2} ⋀ \{ cm .0 \vert cm ∈ {Ce}_{2} ( t ) , m ∈ cm .1 \} = \{ cm .0 \vert cm ∈ {Cb}_{2} ( {t}^{′} ) , m ∈ cm .1 \} ⋀ ⫬ redundant ( t , {t}^{′} , {P}_{2} ) \} \qquad ( 2.1 )$$

Where function redundant: T₂×T₂×P(T₂×T₂)→B determines whether a precedence edge (t,t′) is redundant in a precedence relation P:
redundant(t,t′,P)=(∃t″:t″∈ T₂ \hat{ } t″≠t \hat{ } t″≠t′: path(t,t″,P) \hat{ } path((t″,t′,P)) (2.2)

And where function path: T₂×T₂×P(T₂×T₂)→B determines whether there is a path between two tasks t and t′ in a precedence relation P:

$$path ( t , {t}^{′} , P ) = \{ \begin{matrix}true & if t = {t}^{′} \\ ( ∃ {t}^{″} : ( t , {t}^{″} ) ∈ P : path ( {t}^{″} , t , P ) ) & if t \neq {t}^{′}\end{matrix} \qquad ( 2.3 )$$

The additional constraints that have to be satisfied for transformation B from D2 into Di are as follows:
b-i The resources involved in life of material instance m ∈ M in a TRS definition D₂ ∈ D₂ match (logistic flow integrity):

$$( ∀ t , {t}^{′} : ( t , {t}^{′} ) ∈ {P}_{2 m} ( {D}_{2} , m ) \\ : {I}_{1} ( t ) ⋂ ( ⋃ m : m ∈ {Ce}_{2} ( t ) .1 : A ( {Ce}_{2} ( t ) .0 ) ) \\ : {I}_{1} ( {t}^{′} ) ⋂ ( ⋃ m : m ∈ {Cb}_{2} ( {t}^{′} ) .1 : A ( {Cb}_{2} ( {t}^{′} ) .0 ) ) ) \qquad ( 2.4 )$$
b-ii The combination of involved resources in material transport is physically possible (logistic flow feasibility):

$$\begin{matrix}\begin{matrix}( ∀ t , m , {r}_{b} , {r}_{e} : t ∈ {T}_{1} , m ∈ M , {r}_{b} , {r}_{e} ∈ ℛ , \\ \{ {r}_{b} \} = {I}_{1} ( t ) ⋂ ( ⋃ m \text{:} m ∈ {Cb}_{2} ( t ) .1 \text{:} A ( {Cb}_{2} ( t ) .0 ) ) , \\ \{ {r}_{e} \} = {I}_{1} ( t ) ⋂ ( ⋃ m \text{:} m ∈ {Ce}_{2} ( t ) .1 \text{:} A ( {Ce}_{2} ( t ) .0 ) ) , \\ : {r}_{b =} {r}_{e} ⋁ ( {r}_{b} , {r}_{e} ) ∈ Mf\end{matrix} \\ )\end{matrix} \qquad ( 2.5 )$$
b-iii The material capacity of a resource is not exceeded (material capacity feasibility). Let P₁ᵣ:D₁×R→P(T₁×T₁) be a function describing for each resource r in a TRS definition D₁ ∈ D₁ a linear precedence relation between related tasks, where linear means that the related tasks form a chain:

$$\begin{matrix}{P}_{1 r} ( {D}_{1} , r ) = \{ ( t , {t}^{′} ) \\ \vert ( t , {t}^{′} ) ∈ {P}_{1} \\ ⋀ {I}_{1} ( t ) ⋂ {I}_{1} ( {t}^{′} ) \neq ϕ \\ ⋀ ⫬ redundant ( t , {t}^{′} , {P}_{1} ) \\ \}\end{matrix} \qquad ( 2.6 )$$

Let tchainr: P(T₁×T₁)→T₁* be a function that returns the task chain corresponding with a linear precedence relation P₁.

$$tchainr ( {𝒫}_{1} ) = \{ \begin{matrix}ɛ & if {𝒫}_{1} = Ø \\ [ firstp ( {𝒫}_{1} ) .0 ] ++ tchainr ( {𝒫}_{1} \backslash & if {𝒫}_{1} \neq Ø \\ \{ firstp ( {𝒫}_{1} ) \} ) & \end{matrix} \qquad ( 2.7 )$$

Where a++b denotes concatenation of sequence a and b into ab.

Where function firstp: P(T₁×T₁)→T₁×T₁ determines the first precedence edge in a linear precedence relation P₁:
firstp(P₁)={(t,t′)|(t,t′) ∈ P₁ \hat{ } ( [symbol] t″:t″∈ T₁:(t″,t) ∈ P₁)} (2.8)

Let Sₘ (r,s) be the material configuration of resource r after execution of task sequence s. Before executing any tasks, the material configuration of a resource is given and is defined as the initial material configuration: Sₘ(r,ε)=Sₘ₋ᵢ(r). The material configuration after execution of task sequence st is defined as follows:
Sₘ(r,st)=Sₘ(r,s)\mat(Cb₂(t),r) ∪ mat(Ce₂(t),r) (2.9)

Where function mat: P(C×P(M))×R→P(M) returns the material associated with the capability that has the resource available for it.
mat(CM,r)={m|m ∈ cm.1 \hat{ } cm ∈ CM \hat{ } r ∈ A(cm.0)} (2.10)

Then the material capacity constraint for a TRS definition D₁ ∈ D₁ can be defined as follows:
(∀ r,st:r ∈ R \hat{ } t ∈ T₁ \hat{ }st≦chainr(P₁ᵣ(D₁,r)):|Sₘ(r,st)|≦Rm(r)) (2.11)

Additional constraints are introduced that outline valid extension of a selection to avoid invalid behavior during constructive schedule construction.

Deadlock is possible if the system gets locked, e.g. the situation in the case as is shown in FIG. 20. To avoid this, it is required to make sure that the number of material instances residing on a subset of the resources Rc does not exceed some number r_{c}. For instance, in the case of FIG. 20, the number of material instances in each of the dashed squares may not exceed 2.
b-iv When considering a constructive scheduling algorithm, a partial selection D₁ₚ ∈ D₁ can only be extended with a task t′ and related definition elements to form an extended partial selection D₁ₚ′ 531 D₁ if no WIP ceiling constraints are violated for the extended partial selection. Let WIPceil ∈ P(P(R)×N) be the set of applicable combinations of Rc and n_{c} as described earlier. Then the additional constraint is defined as follows:
   (∀ (Rc,n_{c}:(Rc,n_{c}) ∈ WIPceil:(Σr:r ∈ Rc:|Sₘ(r,tchainr(P₁ᵣ(D₁ₚ′,r)))|)≦n_{c}) (2.12)

In many cases, material transport is performed by resources that can contain only one material instance (one-lane logistic path). This means that the only possible next transport task for such a resource is to transport the material instance further. However, when a constructive scheduling algorithm is applied this can lead to deadlock, as there might be no resource available to receive material, whereas the same resource has to make room on these resources. To avoid these kinds of deadlock situations, the scheduling algorithm has to look a bit further in life of this material instance than the next task only.

To describe these situations, the concept of tied precedences Pt₂ ⊂ P₂ is introduced. When choice of tasks is not considered, like in the generalized job shop scheduling problem, this implies that the subsequent transport tasks of a certain material instance that have to be executed uninterrupted after another are connected by tied precedences. A tie is defined as a chain of tasks that are connected by tied precedences. An open tie is defined as a tie of which at least one but not all tasks are selected.

When considering a constructive scheduling algorithm, the additional constraints concerning ties are as follows:
b-v A partial selection D₁ₚ ∈ D₁ can only be extended with a task t′ from a tie to form an extended partial selection D₁ₚ′ ∈ D₁ if it is possible to subsequently select an entire tie.
b-vi If a partial selection contains an open tie, it can only be extended with a tied task.

In the following, we formulate the possible schedule extensions for a constructive scheduling algorithm.

Let T, T₁ₚ,I₁ₚ,P₁ₚ be the tasks, involved resources and precedence relation of partial selection D₁ₚ. Let T₁ₑ,I₁ₑ,P₁ₑ be the task t′, involved resources with t′ and precedence edges to t′ of selection extension D₁ₑ. Let T₁ₚ′,I₁ₚ′,P₁ₚ′ be the tasks, involved resources and precedence relation of extended partial selection D₁ₚ′, which is equal to T₁ₚ∪T₁ₑ,I₁ₚ∪I₁ₑ,P₁ₚ∪P₁ₑ.

Let function Et: (D₂×D₁)→P(T₁) be the function that determines for a partial selection D₁ₚ all eligible tied next tasks, considering the tied precedence relation.
Et(D₂,D₁ₚ)={t ∈ T₂\T₁ₚ|∀ t′:(t′,t) ∈ P₂:t′∈ T₁ₚ)} (2.13)

Let function Etₜ: (D₂×D₁)→(P(T₁) be a function that determines for a partial selection D₁ₚ all eligible next tasks, considering the tied precedence relation:
Etₜ(D₂,D₁ₚ)={t′|t′ ∈ Et(D₂,D₁ₚ) \hat{ } (∃t:t ∈ T₁ₚ:(t,t′) ∈ P₂ₜ)} (2.14)

Let function Er: (D₂×T₁)→P(R) be a function that determines for a task all eligible sets of involved resources, considering the available resources for the capabilities involved.
Er(D₂,t)={rr ⊂ R|(∀ r,c:r ∈ rr,c ∈ I₂(t):r ∈ A(c))} (2.15)

Let function check_{Cb-i} :through check_{Cb-iii} :((D₂×D₁×T₁×P(R))→B be functions that check whether or not for a next task t′ and involved resources rr′ constraints b-i through b-iii hold.

$$\begin{matrix}{check}_{Cb - i} ( {D}_{2} , {D}_{1 p} , {t}^{′} , {rr}^{′} ) = ( ∀ t : t ∈ {T}_{1 p} ⋀ ( t , {t}^{′} 0 ∈ {P}_{2 m} ( m ) & ( 2.16 ) \\ : {I}_{1} ( t ) ⋂ ( ⋃ m : m ∈ {Ce}_{2} ( t ) .1 : A ( {Ce}_{2} ( t ) .0 ) ) & \\ = {rr}^{′} ⋂ ( ⋃ m : m ∈ {Cb}_{2} ( {t}^{′} 0.1 : A ( {Cb}_{2} ( {t}^{′} ) .0 ) ) & \\ ) & \\ {check}_{Cb - ii} ( {D}_{2} , {D}_{1 p} , {t}^{′} , {rr}^{′} ) = ( ∀ m , {r}_{b} , {r}_{e} : m ∈ {M}_{2} ⩓ {r}_{b} , {r}_{e} ∈ R , & ( 2.17 ) \\ \{ {r}_{b} \} = {rr}^{′} ⋂ ( ⋃ m : m ∈ {Cb}_{2} ( {t}^{′} ) .1 : A ( {Cb}_{2} ( {t}^{′} ) .0 ) ) & \\ \{ {r}_{e} \} = {rr}^{′} ⋂ ( ⋃ m : m ∈ {Ce}_{2} ( {t}^{′} ) .1 : A ( {Ce}_{2} ( {t}^{′} ) .0 ) ) & \\ : {r}_{b} = {r}_{e} ⋁ ( {r}_{b} , {r}_{e} ) ∈ Mf & \\ ) & \\ {check}_{Cb - iii} ( {D}_{2} , {D}_{1 p} , {T}^{′} , {rr}^{′} ) = & ( 2.18 ) \\ ( ∀ r : r ∈ {rr}^{′} : \vert {S}_{m} ( r , tchainr ( {P}_{1 r} ( {D}_{1 p} , r ) ) ++ {t}^{′} ) \vert \leq Rm ( r ) ) & \end{matrix}$$

Let function check_{b-iv}:(D₂×D₁×T₁×P(R)×P(P(R)×N)→B be a function that checks whether or not for a next task t′ and involved resources rr′ constraint b-iv holds.
check_{Cb-iv}(D₂,D₁ₚ,t′,rr,WIPceil)=(∀ (Rc,n_{c}) ∈ WIPceil:(Σr:r′∈ Rc ∩ rr′:|Sₘ(r,tchainr(D₁ₚ,r)++t′)|)≦n_{c})) (2.19)

Let function E: (D₂×D₁)→P(T₁×P(R)×P(T₁×T₁)) be the function that returns for an unselected TRS definition all possible extensions e in the form of task t′, involved resources rr′ and precedences pr′ with which partial schedule D₁ₚ can be extended to form an extended partial schedule D₁ₚ′. D₁ₑ can be determined from e by taking e.0 for T₁ₑ,(e.0, e.1) for I₁ₑ and e.2 for P₁ₑ. Then, function E can be defined as follows:

$$\begin{matrix}E ( {D}_{2} {D}_{1 p} ) = \\ \{ ( {t}^{′} \\ , {rr}^{′} \\ , \{ ( t , {t}^{′} ) \vert ( t , {t}^{′} ) ∈ {P}_{2} \\ ⋁ ( ( {I}_{1 p} ( t ) ⋂ {rr}^{′} \neq Ø ) ⋀ ( ∄ {t}^{″} ∈ {T}_{1 t} : {I}_{1 p} ( {t}^{″} ) \neq ∅ ⋀ ( t , {t}^{″} ) ∉ {P}_{1 p} ) ) \\ \} \\ ) \\ \vert {Et}_{t} ( {D}_{1 p} ) = Ø ⇒ {t}^{′} ∈ Et ( {D}_{2} , {D}_{1 p} ) ⋀ E {t}_{t} ( {D}_{1 p} ) \neq Ø ⇒ \\ {t}^{′} ∈ {Et}_{t} ( {D}_{2} , {D}_{1 p} ) \\ ⋀ {rr}^{′} ∈ Er ( {D}_{2} , {t}^{′} ) \\ ⋀ {check}_{b - i} ( {D}_{2} , {D}_{1 p} , {t}^{′} , {rr}^{′} ) \\ ⋀ {check}_{b - ii} ( {D}_{2} , {D}_{1 p} , {t}^{′} , {rr}^{′} ) \\ ⋀ {check}_{b - iii} ( {D}_{2} , {D}_{1 p} , {t}^{′} , {rr}^{′} ) \\ ⋀ {check}_{b - iv} ( {D}_{2} , {D}_{1 p} , WIPceil , {t}^{′} , {rr}^{′} ) \\ ⋀ ∃ {D}_{1 e}^{′} ∈ {D}_{1} : {Et}_{t} ( {D}_{1 p}^{′} ⋃ {D}_{1 e}^{′} ) = Ø \\ \}\end{matrix} \qquad ( 2.20 )$$

In function E, both the constraints involved in generalized job shop scheduling, and the additional machine-specific scheduling constraints b-i though b-vi can be recognized.

It is also possible to apply a deadlock-avoiding constraint that takes into account the direction of the material (instead of constraints b-iv through b-vi). Such a constraint can be formulated in the form of a configurable function, checking whether a certain material configuration Sₘ including the flow direction of this material (which can be derived from the remainder of the materials' lives) is safe (will not lead to deadlock). Such a function can, for example, be configured using a model checker, such as the Symbolic Model Verifier (SMV) software made available by Carnegie Mellon University, Pittsburgh, Pa. 15213-3890.

In the following text, first, additional machine-specific constraints are introduced to avoid unfeasible timing behavior, then the transformation function is described.

To describe hardware interference, some additional definition elements are defined. Subsequently, constraints are defined using these additional elements. Furthermore, the constraint that must be satisfied in order to time a selected TRS is described. Finally, constraints with respect to task start and finish time are described.

Some state transitions of some resources can only take place synchronously with state transitions of other resources.

Ts ∈ P(R×S×S) gives the subsets of synchronous resource state transitions.

In a machine, certain areas exist in which resources can collide. These areas are allowed to be visited by the resources mutually exclusively. This additional constraint is described by adding a resource to R for such hazardous areas, and involves this resource in every resource state transition that visits this area as described above. For the collision area resources, physical states do not play a role.

R_{c} is a finite set whose elements are called collision areas.

Tc:R×S×S→R_{c} ∪ {Ø} gives the collision area resource that is associated with a certain resource state transition.

The setup transitions might consist of several elementary subtransitions, each of which might be involved with forced synchronism or collision avoidance.

Te:R×S×S→(R×S×S)* gives the elementary subtransitions of a resource state transition. In case there are no elementary subtransitions, the original state transition is returned.

Constraints:

i Every task is elementary:
(∀ t,r:t ∈ T₁ \hat{ } r ∈ I₁(t) ∩ (R\R_{c}):Te(r,Sb₁(t,r),Se₁(t,r))=[(r,Sb₁(t,r),Se₁(t,r))])

ii Every task matches Ts, which implies that for each task t either the resource state transitions involved encapsulate some set of synchronous state transitions s from Ts, or none of the involved resource state transitions occurs in any s from Ts.
(∀ t:t ∈ T₁:(∃s ∈ Ts:s ⊂ (∪r:r ∈ I₁(t):{(r,Sb₁(t,r),Se₁(t,r))})) [symbol] (∀ s:s ∈ Ts:s ∩ (∪ r:r ∈ I₁(t):{(r,Sb₁(t,r),Se₁(t,r))})=Ø))

iii Every task matches Tc, which implies that for each task and each involved resource (excluding hazardous areas) that goes for each resource state transition any involved collision area is involved in the task too:
(∀ t,r:t ∈ T₁ \hat{ } r ∈ I₁(t) ∩ (R\R_{c}):Tc(r,Sb₁(t,r),Se₁(t,r)) ∈ I₁(t))

Note that these constraints essentially hold for every TRS definition level (main=level 1).
1-t A selected TRS D₁ ∈ D₁ is timeable if subsequent task end and begin states in the chain of tasks per resource match:
   (∀ t,t′,r:(t,t′) ∈ tchainr(P₁ᵣ(D₁,r)) \hat{ } rI₁(t) (∩ ∈ I₁(t′) ∩ (R \R_{c}):Se₁(t,r)=Sb₁(t′,r))

Note that although a number of possible sequences of elementary resource state transitions between some possible resource state transition that is implied by selection may be allowed, only one transition is defined by function Te. Furthermore, for each elementary state transition, at most one collision area is defined by function Te.

When taking the issue of forced synchronous and elementary state transitions into account, it is possible that a setup state transition of a resource implies setup state transitions of other resources. These implied state transitions also have to match the states of the resource in turn, which might imply other state transitions, etcetera. To avoid an infinite chain reaction caused by loops, additional constraints are defined.

A core setup transition is defined as the resource state transition of a resource r from the end state of the previous task on r to the begin state of task t ∈ T₂, in case these states do not match. Using this definition, the following constraints have to be satisfied to prevent loops during the transformation into a timeable TRS:
For two core setup transitions necessary for one task t, the sets of resources involved in setup transitions implied by each core setup transition do not overlap. For example, when there are two core setups for resource A and B, and the core setup for resource A implies a synchronous state transition of resource C, then the state transitions implied by the core setup for resource B may not involve resource C.
For any setup transition of resource r′ (either core or implied by other setup transitions), the set of resources involved in setup transitions implied by this setup transition does not contain r′ itself. For example, it is not allowed that a state transition of resource B that is implied by a state transition of resource A on its turn implies a state transition of resource A.
a-i To transform a timeable selected TRS D₁ to a timed TRS D₀, besides the constraints presented in the definition of the general problem, additional constraints can be introduced for the time between certain task start or end times. Examples are the post exposure bake time and the time that a substrate resides at a load robot.

Due to the constraints to ensure one possible finite transformation A of a selected TRS D₁ to a timeable selected TRS D₁^{T}, this transformation can be defined by a function. In the chain of tasks per resource of a definition D₁, additional setup tasks are introduced such that a chain of tasks results that satisfies constraints i, ii, iii, and 1-t to result in a timeable selected TRS D₁^{T}.

Let insert be a function inserting setup tasks and precedence edges in a selected TRS D₁ for all non-matching subsequent task end and begin states defined by insert(D₁)=D₁′ such that:

$$\begin{matrix}( ∀ r , t , {t}^{′} : r ∈ ℛ ⋀ t , {t}^{′} ∈ {T}_{1} : ( t , {t}^{′} ) ∈ {P}_{1 r} ( {D}_{1} , r ) ⋀ {Se}_{1} ( r , t ) \neq & ( 2.21 ) \\ {Sb}_{1} ( r , {t}^{′} ) ( ∃ {t}^{″} : {t}^{″} ∈ {𝒯}_{1}^{′} ⋀ ( t , {t}^{′} ) ∉ {P}_{1}^{′} ⋀ ( t , {t}^{″} ) ∈ {P}_{1}^{′} ⋀ ( {t}^{″} , {t}^{′} ) ∈ {P}_{1}^{′} & \\ : {I}_{1}^{′} ( {t}^{″} ) = \{ r \} ⋀ {Sb}_{1}^{′} ( {t}^{″} , r ) = {Se}_{1} ( t , r ) ⋀ {Se}_{1}^{′} ( {t}^{″} , r ) = {Sb}_{1} ( {t}^{′} , r ) & \\ ) & \\ ) & \end{matrix}$$

and T₁′, P₁′, I₁′, Sb₁′, and Se₁′ are minimal.

Let e=Te(r, Sb₁(t,r),Se₁(t,r)). Let decomp be a function decomposing any compound transitions in setup tasks of a selected TRS to match Te defined by decomp(D₁)=D₁′ such that:

$$\begin{matrix}( ∀ t , r : t ∈ {𝒯}_{1} , r ∈ {I}_{1} ( t ) ⋀ Te ( r , {Sb}_{1} ( r , {t}^{′} ) , {Se}_{1} ( r , t ) ) \neq & ( 2.22 ) \\ ( r , {Sb}_{1} ( r , t ) , {Se}_{1} ( r , t ) ) : ( ∀ 0 \leq i < len ( e ) : & \\ ( ∃ {t}^{′} : {t}^{′} ∈ {T}_{1}^{′} : {I}_{1}^{′} ( {t}^{′} ) = \{ r \} ⋀ {Sb}_{1}^{′} ( {t}^{′} , r ) = e . i .1 ∈ ⋀ {Se}_{1}^{′} ( {t}^{′} , r ) = e . i .2 & \\ ⋀ i = 0 ⇒ ( ∀ {t}^{″} : {t}^{″} ∈ {T}_{1} ⋀ ( {t}^{″} , t ) ∈ {P}_{1 r} ( {D}_{1} , r ) : ( {t}^{″} , t ) ∉ {P}_{1}^{′} ⋀ ( {t}^{′} , {t}^{″} ) ∈ {P}_{1}^{′} & \\ ⋀ i = len ( e ) - 1 ⇒ ( ∀ {t}^{″} : {t}^{″} ∈ {𝒯}_{1} ⋀ ( t , {t}^{″} ) ∈ {P}_{1 r} ( {D}_{1} , r ) : ( t , {t}^{″} ) ∉ {P}_{1}^{′} ⋀ ( {t}^{′} , {t}^{″} ) ∈ {P}_{1}^{′} ) & \\ ) & \\ ) & \\ ) & \end{matrix}$$

and T₁′, P₁′,I₁′,Sb₁′, and Se₁′ are minimal.

Let notsync: D₁→T₁ be a function determining which tasks of a selected TRS are not matching Ts
notsync(D₁)={t ∈ T₁|∃s:s ∈ Ts:s {(r,Sb₁(t,r),Se₁(t,r))|r ∈ I₁(t)})} (2.23)

Let addsync be a function adding forced synchronous resource state transitions to setup tasks of a selected TRS which are not matching Ts defined by addsync(D₁)=D₁′ such that:

$$\begin{matrix}( ∀ t : t ∈ notsync ( {D}_{1} ) : & ( 2.24 ) \\ ( ∀ s , ts : s ∈ Ts , ts ∈ s & \\ : ts ⋂ \{ ( r , {Sb}_{1} ( t , r ) , {Se}_{1} ( t , r ) ) \vert r ∈ {I}_{1} ( t ) \} \neq Ø ⇒ ts .0 ∈ {I}_{1}^{′} ( t ) ⋀ ts = & \\ \{ ( r , {Sb}_{1}^{′} ( t , r ) , {Se}_{1}^{′} ( t , r ) ) \} & \\ ) & \\ ) & \end{matrix}$$

Let addcoll be a function adding collision areas to setup tasks of a selected TRS which are not according Tc: addcoll(D₁)=D₁′ such that:
(∀ t,r:t ∈ T₁ \hat{ } r ∈ I₁(t) ∩ (R\R_{c}) \hat{ } Tc(r,Sb₁(t,r))≠Ø:Tc(r,Sb₁(t,r),Se₁(t,r)) ∈ I₁′(t)) (2.25)

To transform a selected TRS D₁| that does not satisfy constraint 1-t into a selected D₁^{T} that does satisfy constraint 1-t, function trans_{A-t}:D₁→D₁′ is defined as follows:

$${trans}_{A - t} ( {D}_{1} ) = \{ \begin{matrix}addcoll ( decomp ( insert ( {D}_{1} ) ) ) & if notsync ( decomp ( insert ( {D}_{1} ) ) ) = Ø \\ {trans}_{A - t} ( addsync ( decomp ( insert ( {D}_{1} ) ) ) ) & if notsync ( decomp ( insert ( {D}_{1} ) ) ) \neq Ø\end{matrix} \qquad ( 2.26 )$$

Note that trans_{A-t} can also be used in a constructive algorithm.

The algorithm to optimize timing of a timeable selected TRS D₁^{T} given the timing constraints a is a linear programming problem that is solvable by well known techniques. Linear programming can also be used in a constructive algorithm.

For an example system, the additional elements can be defined as follows:
M={W1,W0, . . .}.
Cb₂={(W1-T2L, {(T, {W1)), (L, { })}), (W1-L2R, {(L, {W1}), (R, { })}), . . . }.
Ce₂={(W1-T2L,{(T, { }), L, {W1})}), . . . }
Rm={(T0,1), (L0,1), . . . }
Mf={(T0,L0),(L0,R0),(R0,A0)
Pt₂={(W1-T2L, W1-L2R),(W1-L2R,W1-R2A),(W1-R2A,W1-AL), (W1-AL,W1-A2R),(W1-A2R, W1-R2S),(W1-S2R,W1-R2L), (W1-R2L,W1-L2T), . . . }
WIPceil={({L0,R0,A0,S0},2), ({L1,R1,A1,S1}],2)}
Ts={{(S0, @lm, @e), (S1, @e, @lm)}, {(S1, @lm, @e), (S0, @e, @lm)}}
Rc={HA}
Tc={((R0,@ca,@l),HA), . . . }
Te={((R0,@i, @,a),[(R0, @i, @ca), ),[(R0, @ca, @ca)]),((S0, @lm, @u), [(S0,@lm,@e),(R0,@e,@u)]), . . . }

Using a simple heuristic, namely fill up the system as much as possible and ‘Earliest Start First’, a feasible and valid schedule is obtained. Subsequently, a timing post-processing step is done to fulfill the additional time window constraints
τ_{F}_{₀}(W1-R2S)-τₛ_{₀}(W1-A2R)=3[s], etc., and τ_{F}_{₀}(W1-L2T)−τₛ_{₀}(W1-EXP)=50[s], etc.

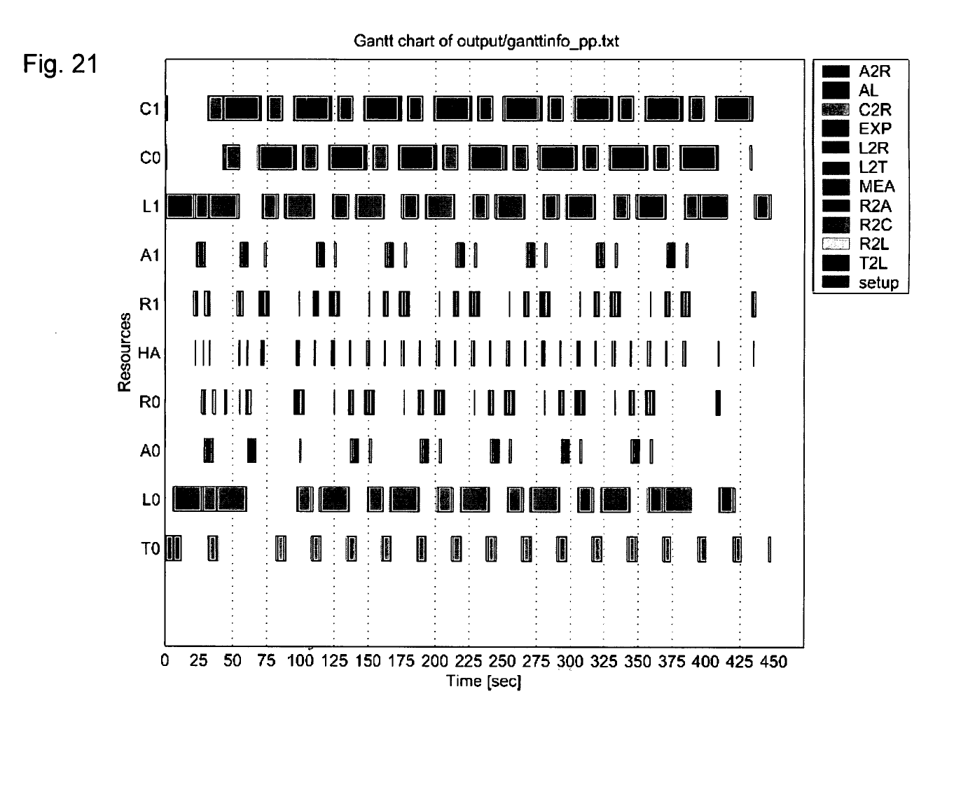

After this, the schedule of FIG. 21 is obtained. It can be concluded that the schedule matches all additional restrictions.

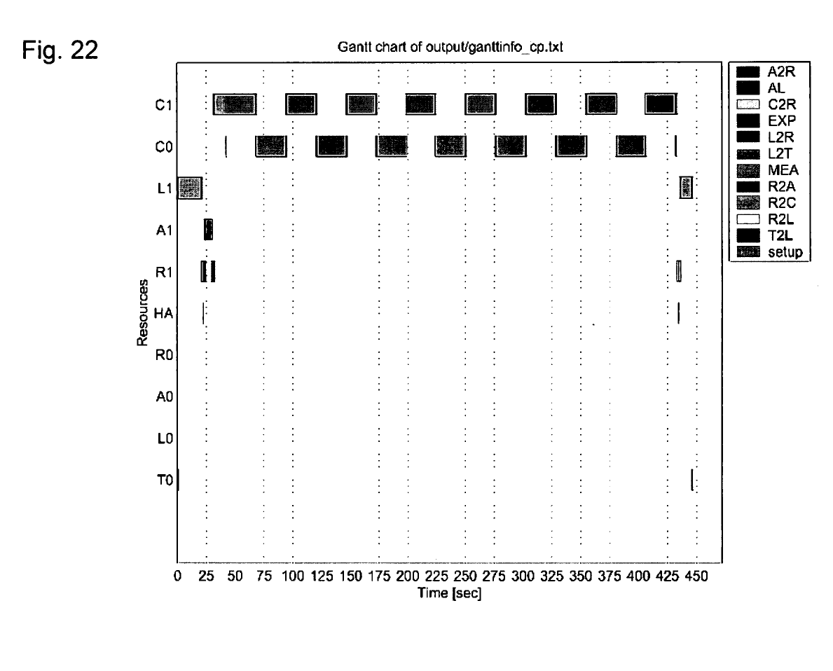

The critical path as is displayed in FIG. 22 is as desired: steady-state exposure is on the critical path.

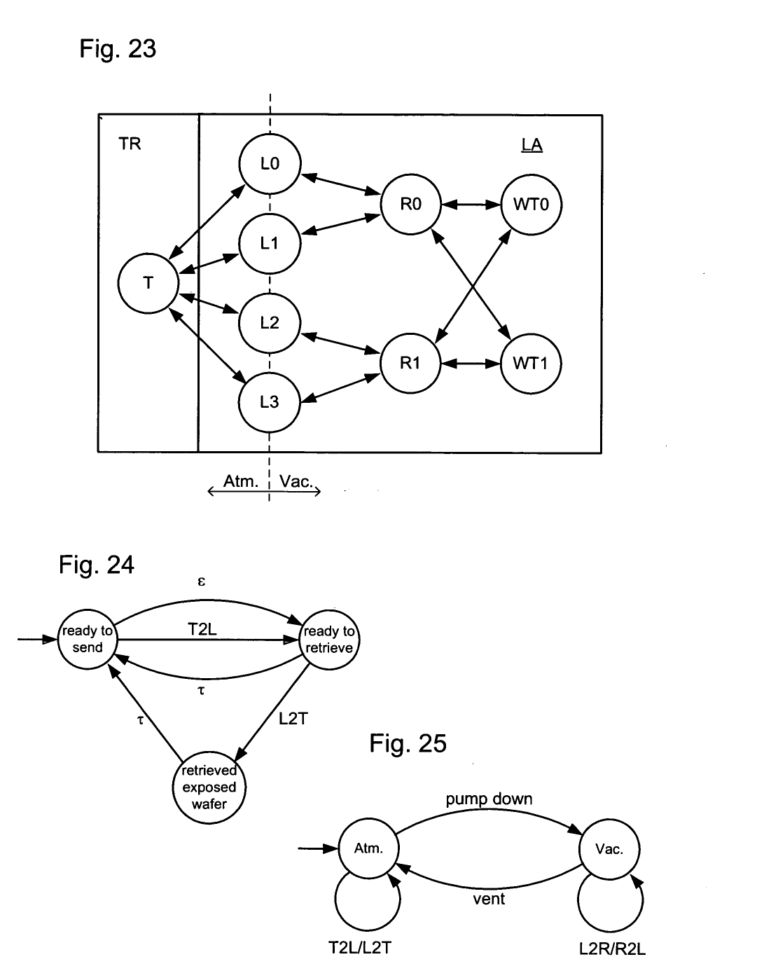

A third embodiment of the invention is a lithographic apparatus, using extreme ultraviolet radiation as the exposure radiation, connected to a track. The substrate flow of the third embodiment is schematically shown in FIG. 23. The circles in the figure represent the resources of the model—one track T, four load locks L0-L3, two robots R0, R1 and two substrate tables WT0, WT1 (also referred to as chucks). The arrows in the figure represent the possible substrate flows through the apparatus. A fresh substrate starts in the track, it is transported to one of the tables, where it is measured and exposed and finally it is transported back to the track.

The track delivers fresh substrates to the lithographic apparatus and retrieves exposed substrates from the lithographic apparatus. A simple model of the track T is used for the purposes of this description, where each time a substrate is retrieved or a new substrate must be delivered, the track needs a certain amount of time to perform internal actions.

The load locks L0-L3 have room for one substrate and are bi-directional, which means that a single load lock can be used for both ingoing and outgoing substrates. After a substrate is put in a load lock, the pressure in the load lock is brought to vacuum for an ingoing substrate or to atmospheric for an outgoing substrate.

The robots R0, R1 in the substrate handler both have two arms, placed at 180° opposite of each other. Each arm can carry one substrate. The robots rotate their arms between the load locks and the chucks. A robot arm can reach two of the four locks when it is at the lock side and it can reach both chucks when it is at the chuck side.

The chucks or substrate tables WT0, WT1 each have room for one substrate. The substrate tables may adopt positions—the load/unload position, the measure position and the exposure position. However, it is also possible to combine the load/unload position with the measure position so that the substrate tables have only two positions. When the substrate table is at the measure position the substrate can be loaded or unloaded by one of the robots. Measurement also requires the substrate table in this position. Exposure takes place at the exposure position. Both substrate tables change positions synchronously during the so-called ‘chuck swap’.

As with the first and second embodiments, the system can be described as an instantiated, unselected TRS definition (class 2). The control strategy of the third embodiment is embodied in a heuristic filter configuration.

In this embodiment, there is one track and there are four load locks, two robots and two substrate tables, which would mean nine resources. However, instead of modeling the robots with a substrate capacity of two substrates, the robot arms of the robots are defined as separate resources that represent separate and unique substrate locations. This is done so because the location of a substrate must be known for the robot, as it influences the behavior concerning the robot rotations. When the robot is modeled as one resource with a material capacity of two substrates, it is unknown on which arm a substrate is residing. This means there are eleven resources, which are numbered from 0 through 10 and stored in R

It is clear that there are four capabilities in the model, namely track, lock, robot arm and substrate table. These capabilities are numbered from 0 through 3 and stored in C.

Several behaviors can be performed by the system. Most of the behaviors concern substrate transport between two resources. The strings representing these transport behaviors are of the form “capability2capability”. For example the transport from the track (T) to a load lock (L) is called “T2L”. There are six transport behaviors, namely “T2L”, “L2R”, “R2C”, “C2R”, “EL”, and “L2T”. Besides these transport behaviors, there are two other behaviors, “measure” and “expose”. All eight behaviors involve certain capabilities, which is defined in I₂. It is clear that for the transport behaviors, the involved capabilities are those where the material is transported between. For the “measure” and “expose” behaviors the involved capability is a substrate table.

In A, the available resources per capability are defined, which is straightforward. All resources except the track have a material capacity of one substrate, which is defined in Rm. The track in the model has infinite room for substrates, but for convenience the material capacity of the track is set to 100 substrates. The possible material flow between resources is defined in Mf: From the track, substrates can be transported to each of the four load locks and from each load lock, substrates can transported to two of the four robot arms. Which robot arms those are, depends on the load lock number corresponding to the arrows in FIG. 23. From the robot arms, substrates can be transported to each substrate table. In the substrate transport from the substrate table back to the track, the reversed material flow as described above is possible. The last two definition elements of the static system definition, Te, and Ts, concern the resource state transitions. Before these are explained, the possible states and state transitions of each resource are defined.

In the track, there is one possible state transition that consists of elementary subtransitions, namely from ‘retrieved exposed substrate’ to ‘ready to retrieve’. This state transition is needed when the track retrieves two exposed substrates subsequently (which will happen at the end of the schedule). This transition consists of two elementary state transitions, namely, the track internal action from ‘retrieved exposed substrate’ to ‘ready to send’ (see FIG. 24) and the bypass transition from ‘ready to send’ to ‘ready to retrieve’. This breakdown into elementary subtransitions is defined in Te. For the locks, the state denotes whether the air is at atmospheric pressure or at vacuum.

The transport tasks involving a lock do not change the state of the lock. Pumping down to vacuum and venting of air (which are both resource setups) are the possible state transitions that change the state. The automaton of a lock is shown in FIG. 25.

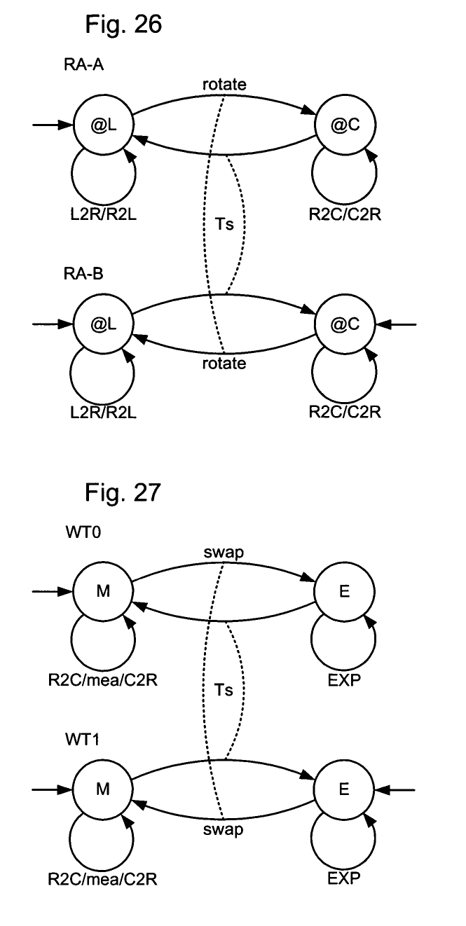

The robot arms and the substrate tables both have two possible states with transitions between them. The robot arms have as state their position, either at lock side or at substrate table side. The state of a substrate table tells whether it is at measure position or at exposure position. The robots and the substrate tables both have forced synchronism, denoted with Ts in the automata of FIGS. 26 and 27 (which also shows the tasks that do not change the resource state). When a robot rotates, the robot arms switch positions, which means that the state transitions of both arms are performed synchronously. The same holds for the substrate tables during the chuck swap, when one substrate table changes position, the other substrate table also changes position.

These synchronous state transitions of the robot arms and of the substrate tables are defined in Ts.

Besides the static system definition described above, other static information must also be defined. The zero order durations for each behavior and for all elementary resource state transitions are defined in Dtz and Dsz, respectively. Because no higher order duration functions are defined which require the hardware capacities defined in Hc (like acceleration and maximum velocity), it is not necessary to define these hardware capacities. Finally, the resource descriptions are defined in resdescr.

The work configuration contains all dynamic information of the TRS, consisting of the dynamic system definition and the initial situation.

The dynamic system definition consists of the definition elements T₂, L₂, G₂, Ln₂, Gn₂, Ga₂, P₂, Pt₂, Tb₂, Sb₂, Se₂, Cb₂, and Ce₂.

In the third embodiment, there are no alternatives concerning tasks, so only tasks are defined and no clusters or groups. For each substrate, eight tasks are defined which correspond to the behaviors mentioned in the previous section. To get a correct manufacturing process for each substrate, the essential precedence relations are defined in P2 between the eight tasks for one substrate, which results in the following life of a substrate: “T2L”, “L2R”, “R2C”, “measure”, “expose”, “C2R”, “R2L”, and finally “L2T”. Also the order of substrates going in the lithographic apparatus is defined using precedence relations between the ingoing tasks (in this case “T2L”) of the different lives of a substrate, resulting in an inflow order with increasing substrate numbers. None of these precedence relations is tied, so Pt₂ is empty.

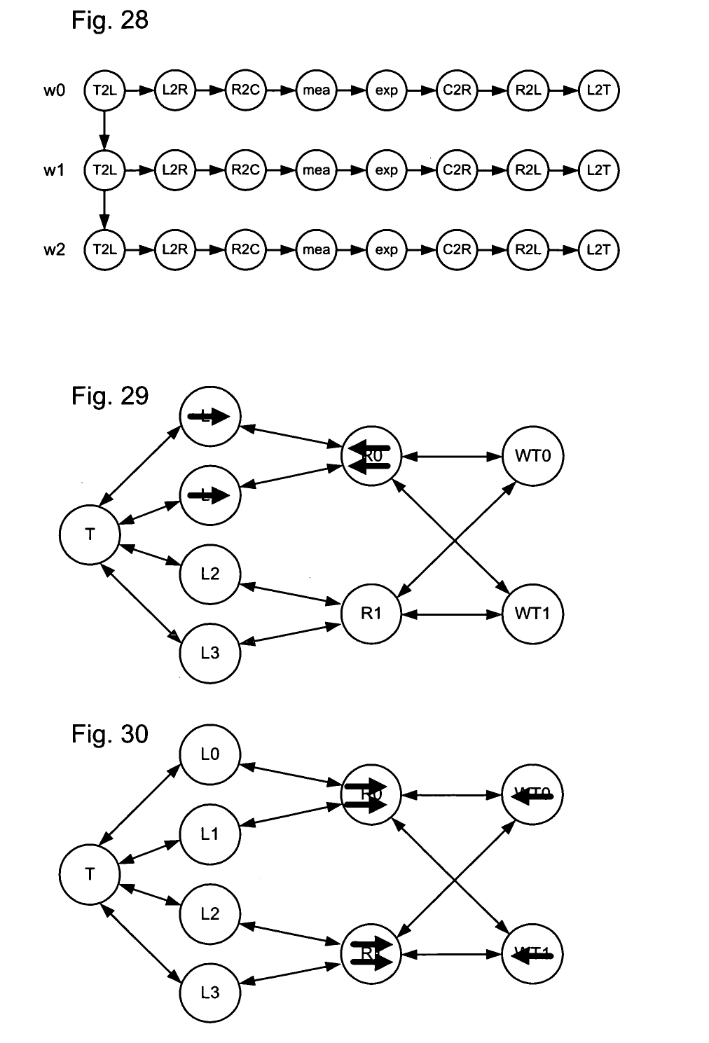

The behaviors mentioned above are assigned to each task in Tb₂. The corresponding task graph that shows three lives of a substrate is shown in FIG. 28.

In Sb2 and Se2, the begin and the end states of each involved capability are defined for each task. In the third embodiment, all transport tasks require the involved capabilities to be at the correct position, such that the transport can be performed. Their state (which is their position) remains unchanged during the task, so the end state is equal to the begin state (see also the automata in FIGS. 24 through 2). However, the state of the track does change during transport tasks. For delivery of a fresh substrate (behavior “T2L”), the track needs to be in state ‘ready to send’, while at the end of the task, the track state is ‘ready to retrieve’. For the retrieval of exposed substrates (behavior “L2T”), the required begin state is ‘ready to retrieve’ and the end state is ‘retrieved exposed substrate’. For “measure” and “expose” tasks, the begin state and the end state are ‘at measure position’ and ‘at exposure position’, respectively.

Finally, the begin and the end material configurations are defined in Cb₂ and Ce₂, respectively. Obviously, for a transport, the delivering capability holds the material at the begin of the task and the receiving capability holds the material at the end of the task. For “measure” and “expose” tasks, the material stays on the capability (in this case a substrate table), so Cb2 and Ce2 are equal for these tasks.

Besides the dynamic system definition described above, the initial situation must be defined. The initial heap is empty, as no tasks are performed yet. For each resource, the initial time (defined in the initial contour) is zero. The initial contour also contains all initial resource states, which is ‘ready to send’ for the track and ‘at atmospheric pressure’ for the load lock. For the robot arms and substrate tables, the initial state is one of the two possible positions, whereas the opposite arm or the other substrate table has the other possible position as initial state.

Next, the heuristic filter configuration design for substrate flow in the third embodiment is described.

Material flow with logistic crossings in a TRS may lead to deadlock situations, which is the case in the present embodiment. After examination of the resource configuration and the possible material flows, the following possible deadlock situations are recognized. First, in a combination of two load locks and a robot, it is possible that both locks have fresh substrates in them and that both robot arms hold an exposed substrate. In this case there is no robot arm free for the fresh substrates and there is no empty lock for the exposed substrates, which means that no further tasks can be performed. An example of this type of deadlock is depicted in FIG. 29, where an arrow denotes a substrate with the direction of the next transport task in its material life.

Also behind the locks, between the robots and substrate tables, a deadlock situation may occur. This is the case when all four robot arms have fresh substrates and both substrate tables are occupied by exposed substrates. This situation is shown in FIG. 30.

Because deadlocks are examples of invalid behavior, constraining filters are used to prevent them. In this case, WIP ceiling is used. For each of the three possible deadlock situations as described above (two lock-robot combinations and one behind the locks), a maxwip filter is defined that checks the WIP ceiling constraint for that group of resources. In the implementation of the T-ReCS scheduler, these three instances of the maxwip filter are combined into one maxwip filter with the three WIP ceiling constraints as filter parameters.

For both lock-robot combinations (two locks and two robot arms), a WIP ceiling of three substrates is set in the filter parameters. The parameters of these maxwip filters are the resource numbers of the two locks and the two robot arms, together with the maximum WIP of three substrates. With this heuristic filter, the type of deadlock depicted in FIG. 29 is prevented. The third maxwip filter concerns all resources behind the locks (four robot arms and two substrate tables) and has as parameters their resource numbers and a maximum WIP of five substrates. With this filter, the situation shown in FIG. 30 cannot be reached any more.

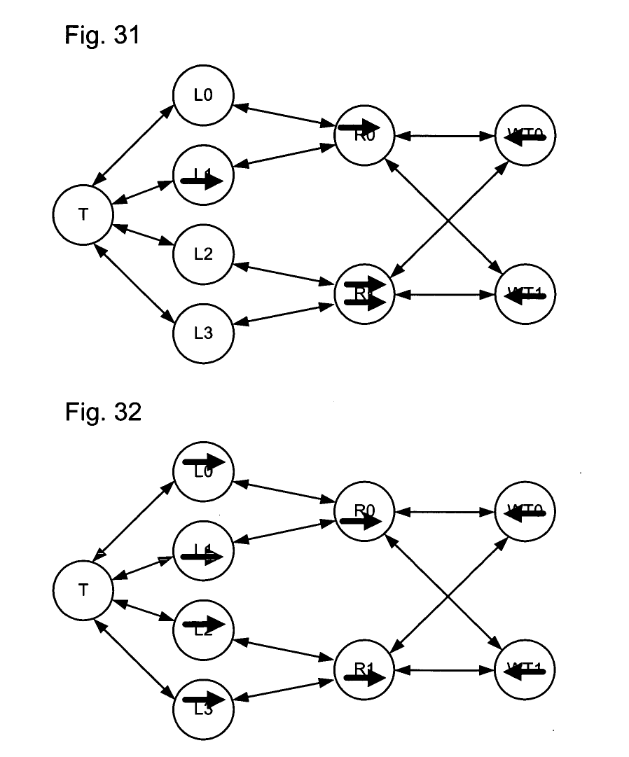

After analysis of the deadlock situation in the counterexample, it became clear that lowering the maximum WIP level behind the locks to four substrates would prevent this deadlock situation. Besides this situation, a similar deadlock situation as in FIG. 31 can still be reached when eight substrates are in the lithographic apparatus. When all locks and one robot arm of each robot hold a fresh substrate, while each substrate table holds an exposed substrate, no WIP ceiling constraint (including the one lowered to four substrates) is violated, however no further tasks can be performed. This situation is depicted in FIG. 32. Again note that this is a deadlock only for the modeled TRS and the used filters. To prevent the last deadlock situation with eight substrates, a fourth maxwip filter is added. This filter has the resource numbers of all resources except the track and a maximum WIP of seven substrates as parameters.

The design process described above only concerns the constraining filters, in this case resulting in four maxwip filters. All generated schedules within this heuristic filter configuration will have valid behavior, which in this case means that the verified property, deadlock freeness, is always satisfied. However, within the valid behavior, some behaviors are more preferred than others. Therefore, two comparing filters are added to the heuristic filter configuration.

To get high resource utilization, it is desired that the number of substrates in the lithographic apparatus is as high as possible. Therefore, the fillmaxwip filter is added to the heuristic filter configuration. The parameters of this filter are the resources where the WIP level should be as high as possible, so in this case all the resources except the track.

Finally, the total schedule time should be as low as possible. This can be accomplished by preferring tasks which have the lowest start times. Therefore, the earliest start first (ESF) filter is used.

Concluding, the heuristic filter configuration consists of four instantiations of the constraining maxwip filter (implemented in one filter), and two comparing filters, the fillmaxwip and the earliest start first (ESF) filter.

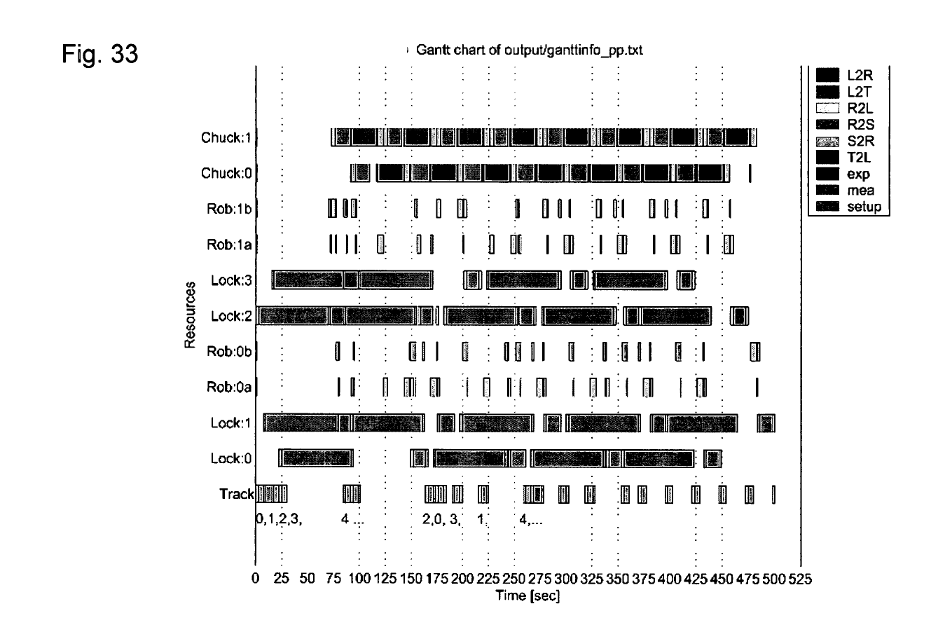

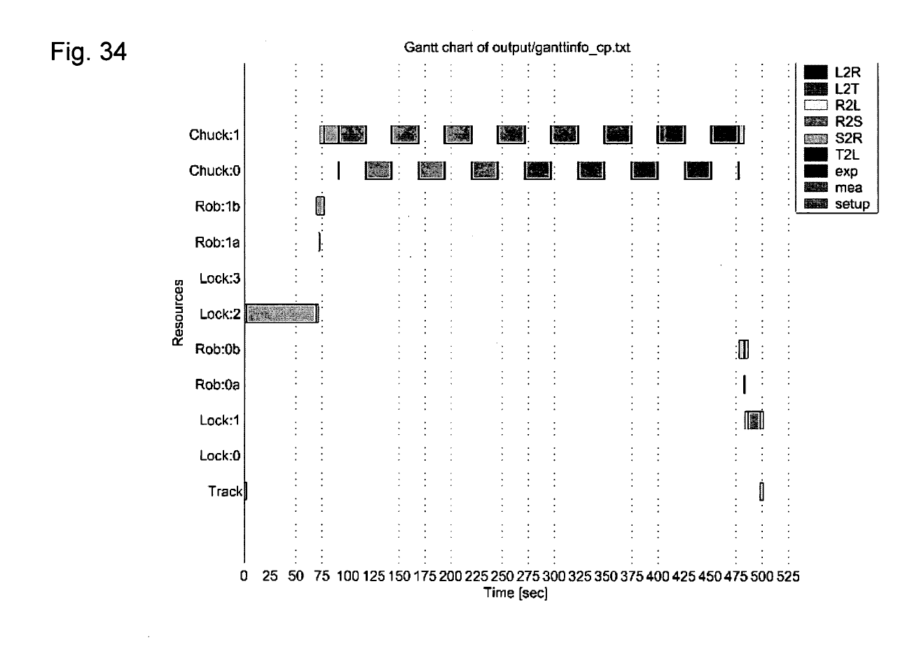

The resulting Gantt chart is shown in FIG. 33 and the critical path in FIG. 34. The lives of all substrates are nicely interweaved, and all exposure tasks are on the critical path. Critical exposures are also desired behavior, because the lens involved in this task is the most expensive part of the lithographic apparatus and should have maximum utilization. As all exposures are on the critical path, the projection lens has the highest utilization possible, which means that this is an optimal schedule concerning exposures.

However, looking at the inflow and the outflow of the substrates (see the substrate numbers in the figure), the order is not FIFO.

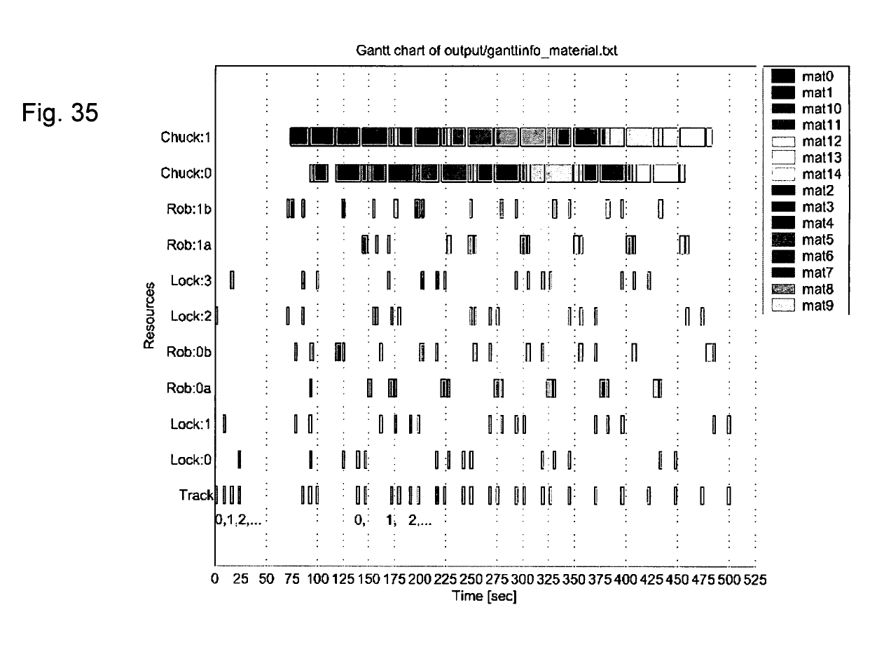

The next experiment demonstrates that it is possible to generate schedules with FIFO order concerning the inflow and the outflow of substrates. The scheduler is guided towards this behavior by applying an additional heuristic filter which makes sure that substrates cannot overtake each other. This filter is the incrmatnr filter that chooses the task with lowest material number when more tasks with the same behavior for different materials are eligible. This filter can be used, because all substrates follow the same logistic path and they enter the lithographic apparatus with increasing substrate number. The only filter parameter of the incrmatnr filter is a list containing the behaviors to which the filter must be applied. When this filter is applied to all behaviors, it is guaranteed that substrates cannot overtake each other and will come out of the system with increasing substrate numbers, which means FIFO order. When this heuristic filter configuration is used in the scheduler, the generated heap (using one shot scheduling) is indeed FIFO. The Gantt chart of this schedule with the substrate numbers is shown in FIG. 35. The schedule is still optimal concerning exposures (which are all on the critical path) and the total schedule time is not increased compared to the schedule found earlier, which means that this schedule is better.

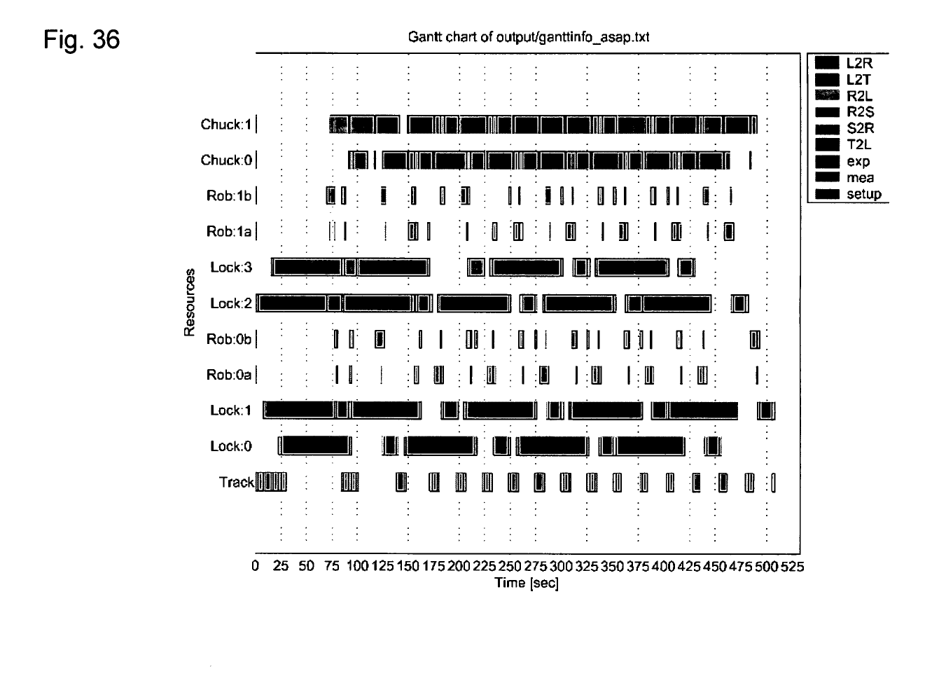

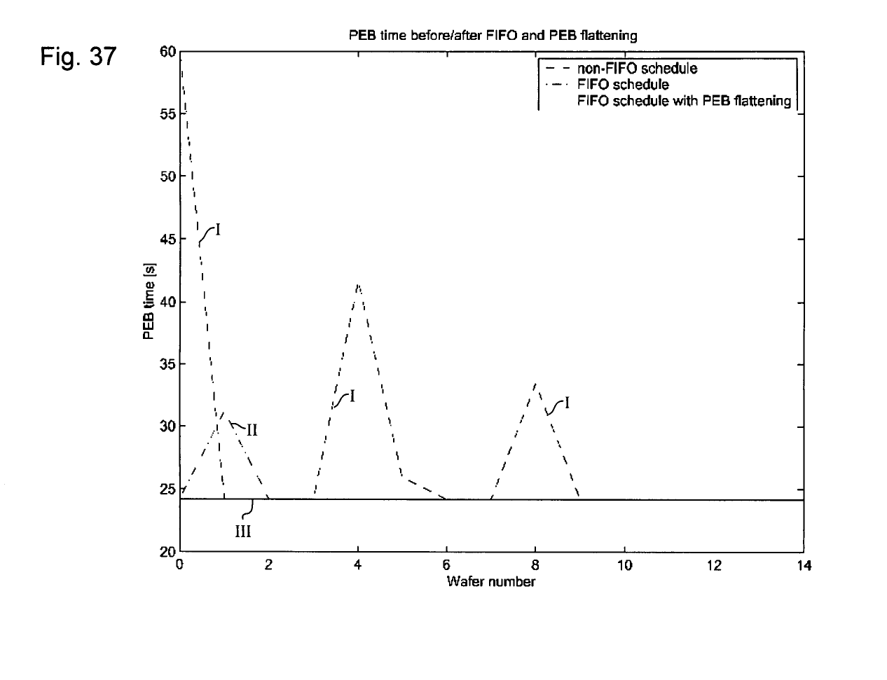

The final experiment concerns the flattening of the post expose bake (PEB) time variability embodiment. The timing post-processor tool is applied and after fine-tuning of the weight functions, the PEB time machine flow variability is reduced to zero. The Gantt chart of the FIFO schedule with flattened PEB time variability is shown in FIG. 36, where the second exposure (on substrate table 0) is delayed (resulting in a gap in the schedule). FIG. 37 shows the PEB times for each substrate for the non-FIFO schedule (I), the FIFO schedule without PEB flattening (II), and the FIFO schedule with PEB flattening (III). The FIFO schedule shows a reasonable improvement in PEB time variability compared to the non-FIFO schedule, however it is not zero, which is accomplished by using timing post-processing.

Scheduling Verification

The schedules described above make use of heuristics to avoid creating schedules, or partial schedules, that may cause undesirable situations such as deadlock or collisions. It is desirable to verify that these heuristics are properly parameterized so as to function correctly. Such verification need only be performed at “design time”—when the scheduler is configured, i.e. its parameters set.

A conventional approach to verification of a model-based problem such as the schedulers described above would be to consider each possible state of the system or model of it to check whether it results in an undesirable situation (state space traversal). Various software model checkers exist to do this automatically. However, in a complex machine such as a lithographic apparatus or lithocell, the number of possible machine states is simply too large for verification by known model checkers, even at design time.

Therefore, in this embodiment of the invention, several approaches are taken to reduce the number of states that need to be considered by the model checkers.

Within the complete tree of all possible states—i.e. the physically feasible behavior of the apparatus as defined by the system definition—there is a reduced set of states, representing valid behavior, determined by deadlock avoidance rules and the like in the scheduler. Within the tree of valid behavior is a further reduced tree representing good or preferred behavior. The scheduler at run-time aims to find a schedule in this tree by the use of heuristics. At design time, it is desirable to check all states in the valid behavior tree to determine whether or not they are, or lead to, an undesirable situation such as a deadlock. If they do not, the scheduler will also not generate a schedule that ends in an undesirable situation at run-time.

To further reduce the processing required for this verification it is necessary to identify states that can be omitted in traversal of the state space. Some approaches to this are:

If two (or more) tasks B and C, which follow task A, can be executed in parallel, it does not matter in state space traversal, whether B or C is visited first (tasks having tau confluence). Thus, considering states in terms of states passed (tp) it is necessary only to consider the states:
tp: {A}
tp: {A,B}
tp: {A,B,C}
   and not the state
tp: {A,C)
   Clearly, the number of states that can be omitted rises rapidly when more than two tasks are executed in parallel. This reduction can be effected by giving priority to tasks having such tau confluence during status space traversal.

Where the apparatus includes multiple resources of the same capability, e.g. substrate tables, load locks, elevators, etc., schedules can be mirrored in them. Thus, if following task A, task B can be performed on either substrate table 1 or substrate table 2, it is only necessary to check the state created by performing it on one of the tables.

Non-logistic tasks, i.e. those which do not affect the properties to be verified by the model checker, e.g. deadlock or the FIFO condition, may be omitted. Examples of such tasks are measurement and exposure tasks as all materials remain at the same resources then. This reduction, and the resource symmetry reduction, can be effected by a hash function.

Using these state space reduction techniques, combinatorial effects leading to state space explosion can be reduced such that practical cases can still be verified.

While specific embodiments of the invention have been described above, it will be appreciated that the invention may be practiced otherwise than as described. The description is not intended to limit the invention.

1. A method of generating a schedule for operation of a machine forming at least a part of a lithographic apparatus or a lithographic processing cell, the method comprising:
receiving a plurality of weight factors for respective ones of a plurality of qualities affecting the outcome of a lithographic process; and
generating an optimum schedule of tasks to be performed to complete said lithographic process, said optimum schedule being one whose outcome has a maximum value of total quality, where total quality is the sum of the products of the values of each of said qualities and the respective weight factors.

2. A method according to claim 1 wherein said schedule specifies an order of tasks to be carried out by said machine and relative timings of at least some of said tasks.

3. A method according to claim 2 wherein said schedule further specifies at least one parameter for at least one task.

4. A method according to claim 1 wherein said weighting factors are defined for a lot of substrates.

5. A method according to claim 1 wherein said qualities are selected from the group comprising:
total post exposure delay time;
variation in post exposure delay time;
the number and/or type of alignment tasks to be carried out;
the degree of optimization of substrate conditioning;
the number, type and/or timing of mask cleaning and inspection tasks;
the speed at which a scan is carried out; and
the degree of optimization of the exposure route.

6. A method according to claim 1 wherein said generation of an optimum schedule comprises:
generating a plurality of schedules;
calculating the total quality value for each generated schedule; and
selecting from among said generated schedules the schedule having the highest total quality value.

7. A method according to claim 1 wherein said generation of the optimum schedule is based upon a model of the machine.

8. A device manufacturing method comprising operating one or more tasks in a lithographic projection apparatus according to the method of claim 1 and projecting a patterned beam of radiation onto a target portion of a substrate.

9. A method of operating a machine forming at least a part of a lithographic apparatus or a lithographic processing cell, the method comprising:
providing a model of the machine in an initial state;
determining eligible tasks that can be performed by the machine based on the state of said model;
selecting one or more of said tasks according to at least one predetermined criterion;
adding the one or more selected tasks to a partial schedule;
updating said model to reflect completion of said one or more selected tasks;
detecting whether the machine is idle and if so controlling it to perform said partial schedule; and
repeating said determining, selecting, adding, updating and detecting until all tasks necessary to complete a lithographic process have been scheduled.

10. A method according to claim 9 further comprising receiving a plurality of weight factors for respective ones of a plurality of qualities affecting the outcome of said lithographic process; and wherein said selecting comprises selecting a task that is most likely to generate an optimum schedule of tasks to be performed to complete said lithographic process said optimum schedule being one whose outcome has a maximum value of total quality, where total quality is the sum of the products of the values of each of said qualities and the respective weight factors.

11. A method according to claim 9, further comprising
receiving a plurality of weight factors for respective ones of a plurality of qualities affecting the outcome of said lithographic process; and
after all tasks necessary to complete a lithographic process have been scheduled, optimizing the schedule to maximize the value of total quality, where total quality is the sum of the products of the values of each of said qualities and the respective weight factors.

12. A method according to claim 11 wherein said optimizing comprises selecting at least one task in said schedule to be performed as late as possible.

13. A method according to claim 12 wherein the task selected to be performed as late as possible is a transport task.

14. A method according to claim 9 wherein, after all tasks necessary to complete a lithographic process have been scheduled, said determining, selecting, adding and detecting are repeated with at least one different selection being made to generate at least one second schedule; and further comprising
selecting from among said schedule and the at least one second schedule an optimum schedule; and
controlling said machine to perform said optimum schedule.

15. A method according to claim 9 wherein among the tasks performable by said machine are a first tied task and a second tied task;
in said determining of eligible tasks, said first tied task is determined to be eligible only if said second tied task is also determined to be eligible; and
if said first tied task is selected to be added to said schedule, said second tied task is automatically also selected for addition to said schedule.

16. A method according to claim 9 wherein said model of said machine includes a count of the number of materials present in a set of resources of the machine and a task that would add a material to the set of resources is ineligible if the addition of the material would increase said count above a predetermined threshold.

17. A method according to claim 9 wherein:
said machine includes at least one collision-hazardous area where there is a possibility of collisions between resources of the machine;
said model includes a virtual resource corresponding to the at least one collision-hazardous area; and
when a task involving a resource entering or crossing the at least one collision-hazardous area is selected, the corresponding virtual resource is marked as occupied for the duration of said task and other tasks that involve a resource entering or crossing that collision-hazardous area are ineligible for selection while said virtual resource is marked as occupied.

18. A device manufacturing method comprising operating one or more tasks in a lithographic projection apparatus according to the method of claim 9 and projecting a patterned beam of radiation onto a target portion of a substrate.

19. A supervisory control system to operate a machine forming at least a part of a lithographic apparatus or a lithographic processing cell, the control system comprising:
an input device configured to receive a plurality of weight factors for respective ones of a plurality of qualities affecting the outcome of a lithographic process; and
a scheduler configured to generate an optimum schedule of tasks to be performed to complete said lithographic process, said optimum schedule being one whose outcome has a maximum value of total quality, where total quality is the sum of the products of the values of each of said qualities and the respective weight factors.

20. A system according to claim 19 wherein said schedule specifies an order of tasks to be carried out by said machine and relative timings of at least some of said tasks.

21. A system according to claim 20 wherein said schedule further specifies at least one parameter for at least one task.

22. A system according to claim 19 wherein said weighting factors are defined for a lot of substrates.

23. A system according to claim 19 wherein said qualities are selected from the group comprising:
total post exposure delay time;
variation in post exposure delay time;
the number and/or type of alignment tasks to be carried out;
the degree of optimization of substrate conditioning;
the number, type and/or timing of mask cleaning and inspection tasks;
the speed at which a scan is carried out; and
the degree of optimization of the exposure route.

24. A system according to claim 19 wherein said scheduler is configured to generate a plurality of schedules, calculate the total quality value for each generated schedule, and select from among said generated schedules the schedule having the highest total quality value as the optimum schedule.

25. A system according to claim 19 wherein said optimum schedule is based upon a model of the machine.

26. A lithographic apparatus comprising:
an illumination system configured to provide a beam of radiation;
a support structure configured to hold a patterning device, the patterning device configured to impart the beam with a pattern in its cross-section;
a substrate table configured to hold a substrate;
a projection system configured to project the patterned beam onto a target portion of the substrate; and
a control system according to claim 19.

27. A track unit comprising substrate handling devices and pre- and post- processing devices and a control system according to claim 19.

28. A lithographic processing cell comprising a lithographic apparatus, a track unit and a control system according to claim 19.

29. A computer program for controlling a machine forming at least a part of a lithographic apparatus or a lithographic processing cell, the program comprising program code that, when executed on a computer system, instructs the computer system to perform:
receiving a plurality of weight factors for respective ones of a plurality of qualities affecting the outcome of a lithographic process;
generating an optimum schedule of tasks to be performed to complete said lithographic process, said optimum schedule being one whose outcome has a maximum value of total quality, where total quality is the sum of the products of the values of each of said qualities and the respective weight factors.

30. A computer program according to claim 29 wherein said schedule specifies an order of tasks to be carried out by said machine and relative timings of at least some of said tasks.

31. A computer program according to claim 30 wherein said schedule further specifies at least one parameter for at least one task.

32. A computer program according to claim 29 wherein said weighting factors are defined for a lot of substrates.

33. A computer program according to claim 29 wherein said qualities are selected from the group comprising:
total post exposure delay time;
variation in post exposure delay time;
the number and/or type of alignment tasks to be carried out;
the degree of optimization of substrate conditioning;
the number, type and/or timing of mask cleaning and inspection tasks;
the speed at which a scan is carried out; and
the degree of optimization of the exposure route.

34. A computer program according to claim 29 wherein said program code that, when executed on a computer system, instructs the computer system to perform generating of an optimum schedule comprises program code that, when executed on a computer system, instructs the computer system to perform:
generating a plurality of schedules;
calculating the total quality value for each generated schedule; and
selecting from among said generated schedules the schedule having the highest, total quality value.

35. A computer program according to claim 29 wherein said generation of the optimum schedule is based upon a model, of the machine.
